(19) United States
(12) Patent Application Publication
(10) Pub. No.: US 2016/0227616 A1
(43) Pub. Date: Aug. 4, 2016

(54) LED DRIVING DEVICE AND LED LIGHTING DEVICE

(71) Applicant: SAMSUNG ELECTRONICS CO., LTD., Suwon-si (KR)

(72) Inventor: SEUNG WOO LEE, HWASEONG-SI (KR)

(21) Appl. No.: 14/973,781

(22) Filed: Dec. 18, 2015

(30) Foreign Application Priority Data
Feb. 4, 2015 (KR) 10-2015-0017204

(51) Int. Cl. H05B 33/08; H05B 37/02; B60Q 1/34; B60Q 1/14

(52) U.S. Cl. CPC H05B 33/0842; B60Q 1/1423; H05B 37/0272; H05B 33/0815; H05B 33/0812; B60Q 1/34

(57) ABSTRACT

A light emitting diode (LED) driving device includes a power supply module configured to supply driving power to a light source, wherein the light source includes a plurality of LED elements, an information acquisition module configured to acquire operating data of the power supply module and characteristic data of the plurality of LED elements, and a control module configured to control an operation of the power supply module based on the operating data and the characteristic data. The information acquisition module and the control module are included in a programmable microcontroller unit (MCU). The MCU executes stored codes to provide control signals to the control module to operate the power supply module.

### CROSS-REFERENCE TO RELATED APPLICATION

This application claims priority under 35 U.S.C. §119 to Korean Patent Application No. 10-2015-0017204, filed on Feb. 4, 2015, in the Korean Intellectual Property Office, the disclosure of which is incorporated by reference herein in its entirety.

### TECHNICAL FIELD

The present inventive concept relates to a Light Emitting Diode (LED) driving device and to an LED lighting device.

### DISCUSSION OF THE RELATED ART

Light Emitting Diodes (LEDs) feature low power consumption, high levels of luminance, and durability. Thus, the use of LEDs as general light sources is increasingly expanding in a number of areas such as lighting equipment, automotive lighting, and backlight units of display devices. Accordingly, research in driving devices that efficiently drive LEDs is being undertaken.

An automotive headlamp may include a plurality of light sources operating independently of each other depending on their respective purposes. For example, the plurality of light sources of an automobile may include low beam lights, high beam lights, daytime running lights (DRL), turn signal lights and the like. When using LEDs in automotive headlamps, more than one LED may be included in each of the plurality of light sources having different purposes with respect to each other, and a driving device for driving the plurality of light sources independently of one another may be required. As a result, circuit complexity and manufacturing costs thereof may increase due to each of the plurality of light sources being provided with a circuit supplying driving power to the plurality of light sources and due to providing a circuit for controlling the driving power of the plurality of light sources. Further, the hardware design of the driving devices may need to be modified to meet the requirements of the specific guidelines applicable to automotive lighting.

### SUMMARY

According to an exemplary embodiment of the present inventive concept, a light emitting diode (LED) driving device includes a power supply module configured to supply driving power to a light source, wherein the light source includes a plurality of LED elements, an information acquisition module configured to acquire operating data of the power supply module and characteristic data of the plurality of LED elements, and a control module configured to control an operation of the power supply module based on the operating data and the characteristic data. The information acquisition module and the control module are included in a programmable microcontroller unit (MCU), and the MCU executes stored codes to provide control signals to the control module to operate the power supply module.

In an exemplary embodiment of the present inventive concept, the information acquisition module includes a monitoring unit configured to detect an input voltage, an input current, an output voltage, or an output current of the power supply module. A bin information detector is configured to detect bin data related to the plurality of LED elements, a temperature detector is configured to detect a temperature of the plurality of LED elements, and a memory unit is configured to store the characteristic data of the plurality of LED elements.

In an exemplary embodiment of the present inventive concept, the characteristic data of the plurality of LED elements includes at least one of current-voltage characteristic data, current-output characteristic data, and junction temperature-output characteristic data, and the memory unit comprises a lookup table including the current-voltage characteristic data, the current-output characteristic data, or the junction temperature-output characteristic data of the plurality of LED elements.

In an exemplary embodiment of the present inventive concept, the control module selects at least one of the characteristic data included in the lookup table based on the bin data detected by the bin information detector, and controls the operation of the power supply module by applying the data detected by the monitoring unit and the temperature detector to the selected characteristic data.

In an exemplary embodiment of the present inventive concept, the control module includes a protection module configured to determine whether to block input power supplied to the power supply module based on the operating data, and an output control module is configured to control a voltage and a current being output by the power supply module based on the operating data or the characteristic data.

In an exemplary embodiment of the present inventive concept, the output control module comprises a Direct Current to Direct Current (DC/DC) controller configured to control a duty ratio of switching elements included in the power supply module, and a linear controller configured to control an output of the power supply module linearly.

In an exemplary embodiment of the present inventive concept, an LED driving device further includes a communications module included in the MCU, wherein the communications module is connected to an external controller to communicate with the external controller.

In an exemplary embodiment of the present inventive concept, the external controller is a body control module (BCM) of a vehicle.

In an exemplary embodiment of the present inventive concept, the plurality of LED elements are arranged in a plurality of LED arrays that operate independently of each other, wherein a first array of the plurality of LED arrays is operated by a first driving voltage that is different from a second driving voltage that operates a second array of the plurality of LED arrays, and wherein the first array of the plurality of LED arrays is operated by a first driving current that is different from a second driving current that operates the second array of the plurality of LED arrays.

In an exemplary embodiment of the present inventive concept, the control module controls the operation of the power supply module when at least one LED array of the plurality of LED arrays is selected to operate based on a driving voltage and a driving current required to operate the selected LED array.

In an exemplary embodiment of the present inventive concept, the MCU includes the power supply module, the information acquisition module, and the control module.

According to an exemplary embodiment of the present inventive concept, an LED lighting device includes a light source including a plurality of LED arrays, a power supply module configured to generate driving power to operate the plurality of LED arrays, and a control module included in an MCU and configured to operate the power supply module based on characteristic data of the plurality of LED arrays and operating data related to the power supply module. The control module includes a stored program executed by the MCU.

In an exemplary embodiment of the present inventive concept, the light source is included in an automotive headlamp, and the plurality of LED arrays provides illumination for low beam lights, high beam lights, daytime running lights (DRL), or turn signal lights of the automotive headlamp.

In an exemplary embodiment of the present inventive concept, the operating data related to the power supply module includes an input voltage, an input current, an output voltage, or an output current of the power supply module, and the characteristic data related to the plurality of LED elements includes bin data, temperature data, current-voltage characteristic data, current-output characteristic data, and junction temperature-output characteristic data related to the plurality of LED elements.

In an exemplary embodiment of the present inventive concept, the characteristic data related to the plurality of LED elements includes current-voltage characteristic data, current-output characteristic data, and junction temperature-output characteristic data, wherein the control module controls the operation of the power supply module using the current-voltage characteristic data, the current-output characteristic data, and the junction temperature-output characteristic data related to the plurality of LED elements, wherein the current-voltage characteristic data, the current-output characteristic data, and the junction temperature-output characteristic data related to the plurality of LED elements are stored in a lookup table.

According to an exemplary embodiment of the present inventive concept, an LED lighting device includes a light source module including a plurality of LEDs, and a power supply module driving the plurality of LEDs. The light source module includes a controller configured to control an operation of the power supply module using a stored program executed by an MCU. The controller controls the operation of the power supply module using characteristic data of the plurality of LEDs and operating data of the power supply module. The plurality of LEDs is arranged into a plurality of LED strings, each LED string of the plurality of LED strings being independently driven by the power supply module.

In an exemplary embodiment of the present inventive concept, the operating data of the power supply module includes an input voltage, an input current, an output voltage, or an output current of the power supply module, and the characteristic data of the plurality of LEDs includes bin data, temperature data, current-voltage characteristic data, current-output characteristic data, and junction temperature-output characteristic data related to the plurality of LEDs.

In an exemplary embodiment of the present inventive concept, the characteristic data of the plurality of LEDs includes current-voltage characteristic data, current-output characteristic data, and junction temperature-output characteristic data,

wherein the controller controls the operation of the power supply module using at least one of the current-voltage characteristic data, the current-output characteristic data, and the junction temperature-output characteristic data related to the plurality of LED elements, and wherein the current-voltage characteristic data, the current-output characteristic data, and the junction temperature-output characteristic data of the plurality of LEDs are stored in a lookup table.

In an exemplary embodiment of the present inventive concept, an LED lighting device further includes a communications module included in the MCU, wherein the communications module is connected to an external controller and is configured to communicate with the external controller.

In an exemplary embodiment of the present inventive concept, the communications module communicates with the external controller using one of visible light wireless communications (LI-FI), WI-FI, and ZIGBEE.

### BRIEF DESCRIPTION OF THE DRAWINGS

The above and other features and aspects of the present inventive concept will be more clearly understood from the following detailed description taken in conjunction with the accompanying drawings, in which:

FIG. 1 is a block diagram illustrating a Light Emitting Diode (LED) driving device, according to an exemplary embodiment of the present inventive concept;

FIG. 2 is a perspective view illustrating an automotive headlamp operated by an LED driving device, according to an exemplary embodiment of the present inventive concept;

FIG. 3 is a block diagram illustrating an LED lighting device, according to an exemplary embodiment of the present inventive concept;

FIG. 4 illustrates a circuit diagram of the LED lighting device of FIG. 3, according to an exemplary embodiment of the present inventive concept;

FIG. 5 is a block diagram illustrating an LED lighting device, according to an exemplary embodiment of the present inventive concept;

FIG. 6 illustrates a circuit diagram of the LED lighting device of FIG. 5, according to an exemplary embodiment of the present inventive concept;

FIG. 7 is a diagram illustrating a microcontroller unit (MCU) that may be applied to an LED driving device, according to an exemplary embodiment of the present inventive concept;

FIGS. 8 and 9 illustrate an active protection function of an LED driving apparatus, according to an exemplary embodiment of the present inventive concept;

FIG. 10 illustrates an active protection function of an LED driving device, according to an exemplary embodiment of the present inventive concept;

FIG. 11 illustrates a graph of the active control function of the LED driving device of FIG. 10, according to an exemplary embodiment of the present inventive concept;

FIG. 12 illustrates a configuration of an automobile to which an LED driving device is applied, according to an exemplary embodiment of the present inventive concept;

FIG. 13 is a perspective view illustrating a flat lighting device to which an LED driving device is applied, according to an exemplary embodiment of the present inventive concept;

FIG. 14 is an exploded perspective view illustrating a bulb-type lamp as a lighting device to which an LED driving device is applied, according to an exemplary embodiment of the present inventive concept;

FIG. 15 is an exploded perspective view schematically illustrating a bar-type lamp as a lighting device to which an LED driving device is applied, according to an exemplary embodiment of the present inventive concept;

FIG. 16 is an exploded perspective view schematically illustrating a lamp including a communications module as a lighting device to which an LED driving device is applied, according to an exemplary embodiment of the present inventive concept; and

FIGS. 17 to 19 are schematic views illustrating illumination control network systems to which an LED driving device is applied, according to exemplary embodiments of the present inventive concept.

### DETAILED DESCRIPTION OF THE EMBODIMENTS

Hereinafter, exemplary embodiments of the present inventive concept will be described in detail with reference to the accompanying drawings.

The present inventive concept may, however, be embodied in many different forms, and should not be construed as being limited to the specific embodiments set forth herein. Rather, these embodiments are provided so that this disclosure is thorough and complete, and will convey the scope of the present inventive concept to those skilled in the art.

In the drawings, the shapes and dimensions of elements may be exaggerated for clarity, and like reference numerals may refer to like elements throughout the specification.

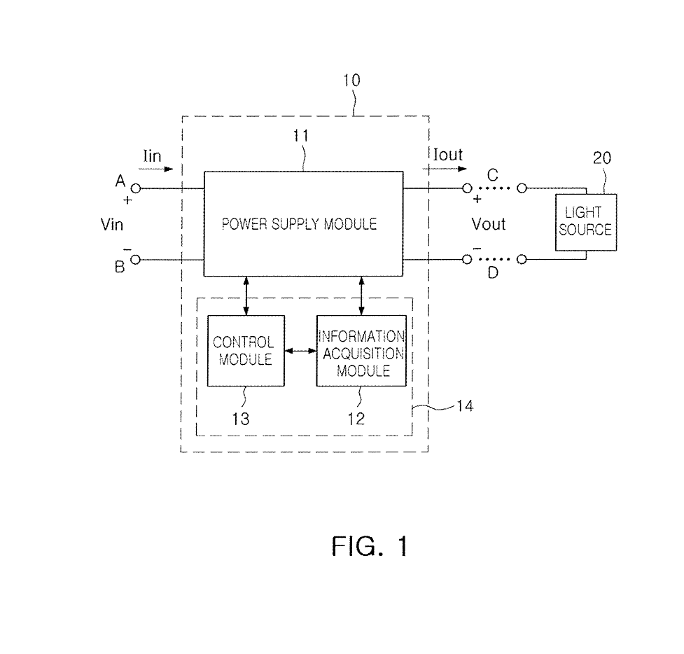

FIG. 1 is a block diagram illustrating a Light Emitting Diode (LED) driving device, according to an exemplary embodiment of the present inventive concept.

Referring to FIG. 1, an LED driving device 10, according to an exemplary embodiment of the present inventive concept, may include a power supply module 11, an information acquisition module 12, a control module 13, and the like. The power supply module 11 may be supplied with input power through input terminals A and B, and may discharge output power through output terminals C and D. Input power may be defined as an input voltage Vᵢₙ and an input current Iᵢₙ, and output power may be defined as an output voltage Vₒᵤₜ and output current Iₒᵤₜ. Output terminals C and D may be connected to a light source 20 having at least one LED element. In an exemplary embodiment of the present inventive concept, the light source 20 may be a light source for lighting devices or an automotive headlamp, and the like, and in a case in which the light source 20 is an automotive headlamp, the light source 20 may include a plurality of LED arrays capable of operating independently of each other.

The power supply module 11 may generate output power from input power transmitted through the input terminals A and B. The output power may be power suitable for driving a plurality of the LEDs included in the light source 20. For example, the power supply module 11 may supply the output current Iₒᵤₜ to the light source 20 through the output terminals C and D.

The information acquisition module 12 may collect various data from the power supply module 11. In an exemplary embodiment of the present inventive concept, the information acquisition module 12 may acquire operating data related to the power supply module 11 and characteristic data related to a plurality of LED elements included in the light source 20. The operating data related to the power supply module 11 may include a portion of the input voltage Vᵢₙ and the input current Iᵢₙ being input to the power supply module 11, and the output voltage Vₒᵤₜ, and the output current Iₒᵤₜ being output from the power supply module 11. Characteristic data related to a plurality of LED elements may include bin data related to a plurality of LED elements or a temperature of the plurality of LED elements, and the like. The bin data related to the LED elements may have a fixed value, and may be used in calculating a junction temperature, a reference value of forward voltage, and the like, of the LED elements.

In an exemplary embodiment of the present inventive concept, the information acquisition module 12 may include a memory. The memory included in the information acquisition module 12 may include a lookup table storing current-voltage characteristic data, current-output characteristic data, or junction temperature-output characteristic data related to the plurality of LED elements. The plurality of LED elements may display current-voltage characteristics, current-output characteristics, junction temperature-output characteristics, and the like, which may be different from each other. The plurality of LED elements may display processing conditions, and the like. The lookup table may store the current-voltage characteristics, the current-output characteristics, the junction temperature-output characteristics, and the like, for each LED element. For example, the bin data related to the LED elements and luminous flux values thereof may be stored in a memory unit in a lookup table such as in Table 1 below.

TABLE 1

| | Luminous flux | Luminous flux | Luminous flux |
|---|---|---|---|
| Bin # | minimum value | maximum value | typ. |
| KY | 82 | 97 | 89.5 |
| KZ | 97 | 112 | 104.5 |
| LX | 112 | 130 | 121 |

The current-voltage characteristic, the current-output characteristic, and the junction temperature-output characteristic of each LED element may be represented using a line graph. The line of the graph may have a predetermined curve. For example, the current-voltage characteristic of a particular LED element may be a characteristic of that LED element reflecting a relationship between a current flowing in that LED element and a forward voltage measured in that LED element. When an x-axis of a graph is defined as a voltage level and a y-axis of the graph is defined as the amount of current, the current-voltage characteristic of an LED element may be illustrated in a manner similar to that of a quadratic function, and a lookup table may store data related to the quadratic function representing the current-voltage characteristic of the LED element.

The control module 13 may control the operation of the power supply module 11 based on operating data and characteristic data acquired by the information acquisition module 12. The control module 13 may include an output control module adjusting the output voltage Vₒᵤₜ and the output current Iₒᵤₜ of the power supply module 11, a protection module that may block input power supplied to the power supply module 11, and the like.

The output control module may include a Direct Current to Direct Current (DC/DC) controller or a linear controller, and may control operation of the power supply module 11 based on the operating data and the characteristic data provided by the information acquisition module 12. The output control module may include an arithmetic logic. In a case in which the power supply module 11 includes a DC/DC converter such as a buck converter or a boost converter, the output control module may adjust an output voltage and an output current of the DC/DC converter by adjusting the duty ratio of a switching element included in the DC/DC converter. A linear controller may be connected to a current regulator connected between the light source 20 and a ground terminal, and may adjust the operation of the switching element included in the current regulator. The protection module may selectively block input power input to the power supply module 11 in accordance with an operation status of the power supply module 11 or the light source 20.

The information acquisition module 12 and the control module 13 may be included in a single (MCU) 14. The information acquisition module 12 and the control module 13 may be included in a programmable MCU 14, and may provide various functions with a program executed in the MCU 14. For example, in the case of the light source 20 being an automotive headlamp, operating characteristics of the headlamp set forth in guidelines applicable to automotive lighting, and the like, may differ from one country to another in which automobiles equipped with the headlamp are sold. In this case, light having a desired property may be output by a headlamp by inputting a new program to the MCU 14 or inputting new parameter values for the same program, without having to design new hardware to drive the headlamp.

In addition, since the MCU 14 has a calculating function, the MCU 14 may protect the LED elements included in the light source 20 and increase power efficiency by actively setting a threshold value of current and voltage in accordance with operating conditions of the light source 20. According to an exemplary embodiment of the present inventive concept, the power supply module 11, the information acquisition module 12 and the control module 13 may be included in the MCU 14. In this case, the power supply module 11 of a wide range of topologies, such as a buck converter, a boost converter, a buck-boost converter, a flyback converter, and the like, may be implemented without hardware changes in accordance with a program running in the MCU 14.

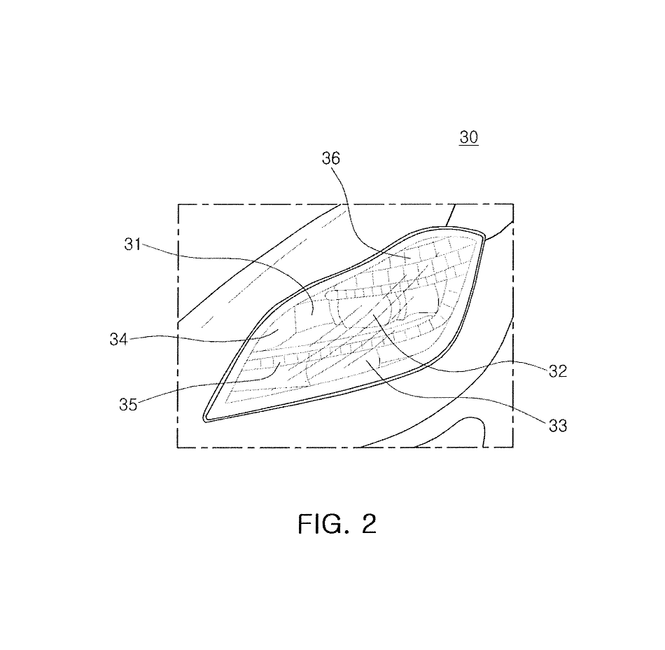

FIG. 2 is a perspective view illustrating an automotive headlamp operated by an LED driving device, according to an exemplary embodiment of the present inventive concept. The LED driving device, according to various exemplary embodiments of the present inventive concept, may be capable of operating a light source including one or more LED elements, in addition to operating the automotive headlamp illustrated in FIG. 2. An automotive headlamp 30, illustrated in FIG. 2, may include the light source 20 operated by the LED driving device 10 illustrated in FIG. 1.

With reference to FIG. 2, the automotive headlamp 30, according to an exemplary embodiment of the present inventive concept, may include a plurality of light sources emitting light for different uses with respect to each other. The automotive headlamp 30 may include low beam lights 31 and 32, high beam lights 33, cornering lights 34, daytime running lights (DRL) 35, turn signal lights 36, and the like. The respective light sources 31 to 36 may be provided in the automobile headlamp 30 for the uses differing from each other, and may respectively include LED elements of different colors or different numbers of LED elements. Therefore, the voltage and current required for the operation of the respective light sources 31 to 36 may also differ from each other.

In a case of operating the respective light sources 31 to 36 using only hardware, the respective light sources 31 to 36 may require at least one power supply circuit and a control circuit for controlling the power supply circuit, a car battery or a filter circuit for filtering power supplied from a generator, and the like. Therefore, the overall circuit complexity and manufacturing costs may be significantly increased, resulting in difficulty in maintenance and repairs. Also, in a case of a geographical region being changed through automobile exports, and the like, it may be difficult to adjust the optical axis, brightness, and the like, of the respective light sources 31 to 36 in accordance with the relevant guidelines.

According to an exemplary embodiment of the present inventive concept, the respective operations of the plurality of light sources 31 to 36 included in the automotive headlamp 30 may be controlled by a single MCU. Since operating characteristics of the respective light sources 31 to 36, for example, the brightness or optical axis thereof, may be modified with a program running in the MCU, light being output by the light sources 31 to 36 may be adjusted to meet a variety of desired conditions without altering the hardware design. In addition, optimized driving power may be supplied to the turned-on light sources 31 to 36 by actively setting a voltage threshold value or a current threshold value differently according to the turned on light sources 31 to 36.

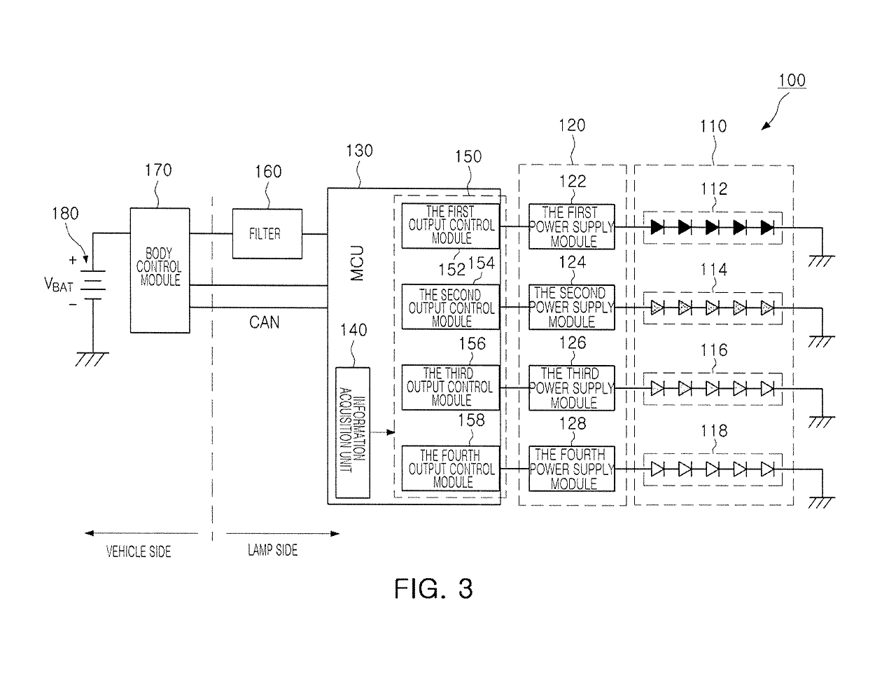

FIG. 3 is a block diagram illustrating an LED lighting device, according to an exemplary embodiment of the present inventive concept.

Referring to FIG. 3, an LED lighting device 100, according to an exemplary embodiment of the present inventive concept, may include a light source 110, a power supply module 120 supplying driving power to the light source 110, an MCU 130 controlling the operation of the power supply module 120, and the like. The LED lighting device 100, according to an exemplary embodiment of the present inventive concept, with reference to FIG. 3, illustrates an automotive headlamp. However, the LED lighting device 100 may also be a lighting device included in a range of industrial and household lighting devices.

The light source 110 may include a plurality of LED modules. The plurality of LED modules may each include at least one or more LED arrays. For example, an LED module includes first, second, third, and fourth LED arrays 112, 114, 116 and 118, respectively, and the first to fourth LED arrays 112 to 118 may have different operating characteristics with respect to each other. For example, the first to fourth LED arrays 112 to 118 may output light of different colors or different levels of brightness with respect to each other. The first to fourth LED arrays 112 to 118 may include different numbers of LED elements with respect to each other. Since the first to fourth LED arrays 112 to 118 may output light of different characteristics with respect to each other, the first to fourth LED arrays 112 to 118 may respectively be applied to light sources (e.g., low beam lights, high beam lights, turn signal lights, daytime running lights, fog lights, and the like) with different purposes with respect to each other.

The power supply module 120 may supply driving power to the first to fourth LED arrays 112 to 118. In an exemplary embodiment of the present inventive concept, with reference to FIG. 3, the input power for generating driving power is generated from a battery or a generator provided in an automobile, and thus, the power supply module 120 may include a DC/DC converter. The power supply module 120 may include first, second, third, and fourth power supply modules 122, 124, 126, and 128 supplying a driving power to the first to fourth LED arrays 112 to 118, respectively. The first to fourth power supply modules 122 to 128 may all be implemented as DC/DC converters having the same topology, or may be implemented as DC/DC converters having different topologies.

An MCU 130 may include an information acquisition module 140, a control module 150, and the like. The information acquisition module 140 may include a circuit detecting bin data related to the LED elements included in the first to fourth LED arrays 112 to 118, a temperature of the LED elements, an input/output voltage, an input/output current of the first to fourth power supply modules 122 to 128, and the like.

The control module 150 may include the first to fourth output control modules 152 to 158. The first to fourth output control modules 152 to 158 included in the control module 150 may correspond to the first to fourth power supply modules 122 to 128, respectively. The first to fourth output control modules 152 to 158 may respectively adjust the duty ratio of the switching element included in a DC/DC converter in order to adjust the output current and the output voltage of the DC/DC converter included in the first to fourth power supply modules 122 to 128.

The duty ratio value adjusted by the first to fourth output control modules 152 to 158 may be determined by the temperature of LED elements of the light source 110 detected by the information acquisition module 140, bin data, the input/output voltage and input/output current of the first to fourth power supply modules 122 to 128, and the like. For example, in a case in which the output current is reduced from an increase in temperature of LED elements included in the second LED array 114, to prevent the decline of output of the second LED array 114, the second output control module 154 may increase the duty ratio value supplied to the second power supply module 124. The MCU 130 may actively control the driving power supplied to the LED elements of the LED arrays 112 to 118 according to changes in the operating conditions and environmental conditions of the LED elements included in the light source 110, and may increase operating efficiency and prevent lifespan shortages of the LED elements included in the LED arrays 112 to 118.

Input power required by the power supply module 120 to supply driving power to the light source 110 may be transmitted by a battery 180 of an automobile, and the like. The battery 180 may output a V_{BAT} voltage. Power output by the battery 180 may be transmitted to the MCU 130 through a filter 160 after being converted to a voltage adequate for an operation of the MCU 130 by a body control module 170. The MCU 130 and the body control module 170 may be connected by a specific communications interface method such as a Controller Area Network (CAN) protocol, and the like, to allow for communications. In addition to CAN, other protocols such as a Local Interconnect Network (LIN) protocol, a FLEXRAY protocol, and the like, may be applied to communications between the MCU 130 and the body control module 170.

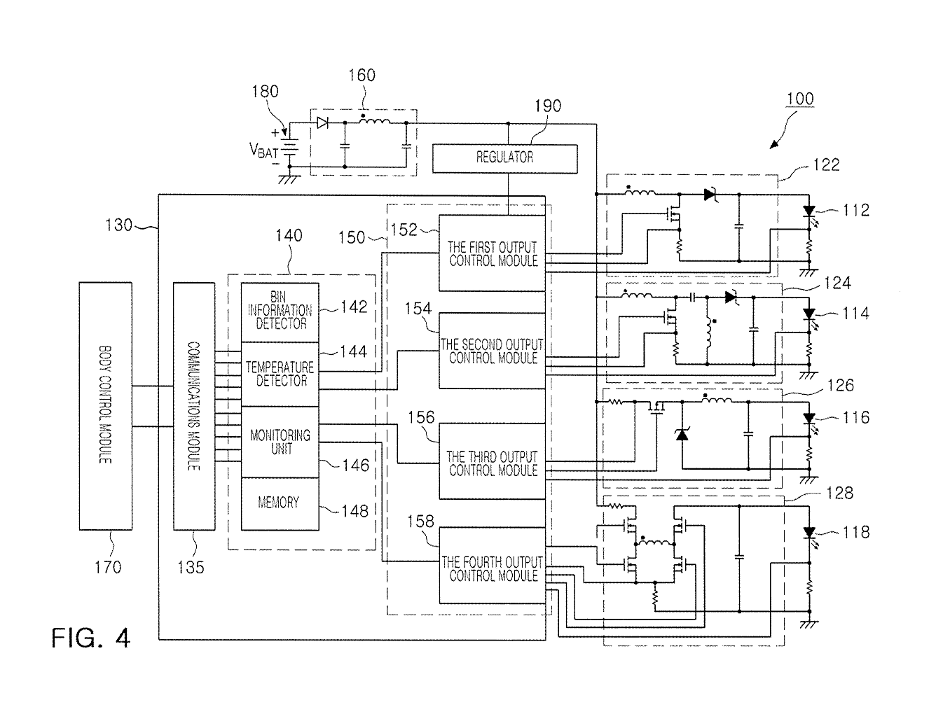

FIG. 4 illustrates a circuit diagram of the LED lighting device of FIG. 3, according to an exemplary embodiment of the present inventive concept.

Referring to FIG. 4, an LED lighting device 100, according to an exemplary embodiment of the present inventive concept, may include a battery 180 supplying Direct Current (DC) power, a filter 160 for removing noise components from the DC power being output by the battery 180, first, second, third, and fourth LED arrays 112, 114, 116, and 118, first, second, third, and fourth power supply modules 122, 124, 126, and 128 supplying driving power to the respective LED arrays 122 to 128, an MCU 130 controlling the operation of the respective power supply modules 122 to 128, and the like. Power required for the operation of the MCU 130 may be supplied by a regulator 190 using DC power passed through the filter 160.

The MCU 130 may be connected to allow communications with a body control module 170 via a communications module 135. As described above, the MCU 130 and the body control module 170 may be connected to each other by a communications protocol such as CAN, LIN, FLEXRAY, and the like. The body control module 170 may transmit vehicle operating data, and the like, to the MCU 130 via the communications module 135, and an information acquisition module 140 may collect vehicle operating data, and the like, transmitted by the body control module 170. The vehicle operating data may include vehicle driving environment conditions, for example, amount of sunlight, precipitation, vehicle operating speed, steering wheel operating conditions, and the like.

The information acquisition module 140 may include a bin information detector 142, a temperature detector 144, a monitoring unit 146, a memory 148, and the like. The bin information detector 142 may detect bin data related to the LED elements included in the first to fourth LED arrays 112 to 118, and the temperature detector 144 may measure the temperature of the LED elements included in the first to fourth LED arrays 112 to 118. Therefore, the bin information detector 142 may be connected to a bin resistor of the LED elements included in the first to fourth LED arrays 112 to 118, and the temperature detector 144 may be connected to a thermistor connected to the LED elements included in the first to fourth LED arrays 112 to 118.

The monitoring unit 146 may detect an input/output voltage, an input/output current, and the like, of the first to fourth power supply modules 122 to 128. The memory 148 may store characteristic data related to the LED elements included in the first to fourth LED arrays 112 to 118, for example, current-voltage characteristic data, current-output characteristic data, junction temperature-output characteristic data, or the like, of the LED elements. The characteristic data may be stored in a lookup table form in the memory 148.

Data acquired by the information acquisition module 140 may be transmitted to a control module 150. The control module 150 may include first, second, third, and fourth output control modules 152, 154, 156, and 158, and the first to fourth output control modules 152 to 158 may adjust the output of the DC/DC converter included in each of the first to fourth power supply modules 122 to 128, respectively. In an exemplary embodiment of the present inventive concept, the first to fourth output control modules 152 to 158 may each include a DC/DC controller.

The first to fourth power supply modules 122 to 128 may include a DC/DC converter. Referring to FIG. 4, the first and the second power supply modules 122 and 124 may include a boost converter, the third power supply module 126 may include a buck converter, and the fourth power supply module 128 may include a full-bridge converter. In the case in which the first to fourth power supply modules 122 to 128 include a DC/DC converter of a topology described above, the first to fourth LED arrays 112 to 118 may be applied sequentially as light sources for low beam lights, high beam lights, daytime running lights, and turn signal lights. The first to fourth output control modules 152 to 158 may respectively include a pulse-width modulation (PWM) signal generating circuit, an analog to digital converter (ADC) circuit, a digital to analog converter (DAC) circuit, a comparator, or the like.

In an exemplary embodiment of the present inventive concept, with reference to FIG. 4, the first to fourth LED arrays 112 to 118 may respectively be operated by the first to fourth power supply modules 122 to 128. Since each of the first to fourth LED arrays 112 to 118 may operate by being supplied with different amounts of driving power, the respective LED arrays 112 to 118 can be operated with high efficiency. In addition, external environmental conditions and operating conditions may be detected by a program running in the MCU 130, and the driving power supplied to each of the respective LED arrays 112 to 118 may be actively excluded accordingly. The first to fourth power supply modules 122 to 128 may be provided in a modularized state together with the MCU 130.

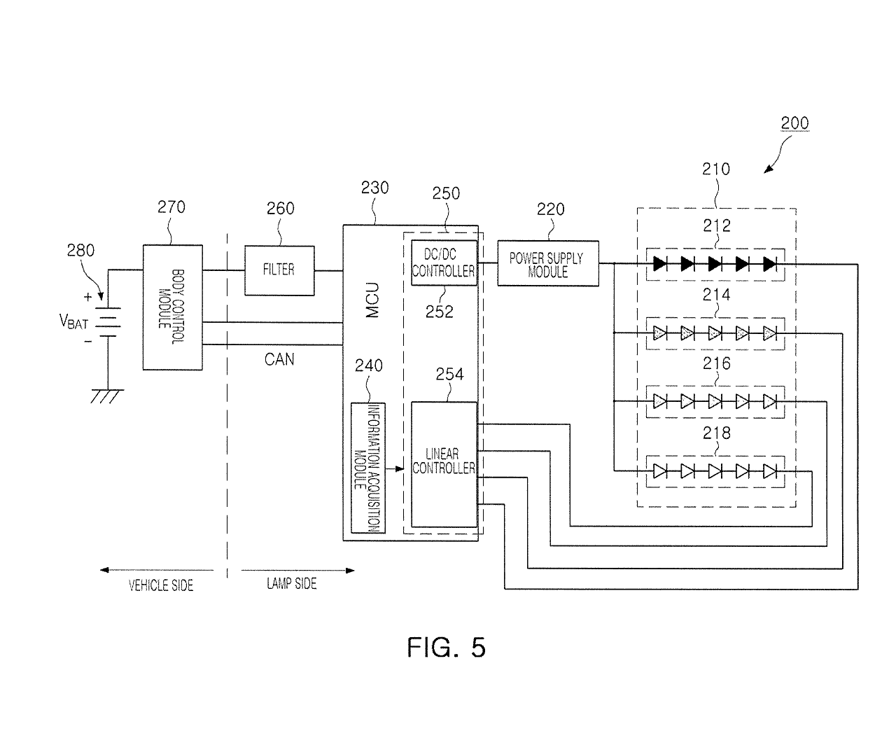

FIG. 5 is a block diagram illustrating an LED lighting device, according to an exemplary embodiment of the present inventive concept.

Referring to FIG. 5, an LED lighting device 200, according to an exemplary embodiment of the present inventive concept, may include a light source 210, a power supply module 220, an MCU 230, and the like. As described above with reference to FIG. 3, power required for the operation of the light source 210 and the MCU 230 may be transmitted by a battery 280 of an automobile. An output voltage V_{BAT} of the battery 280 may be converted to an appropriate voltage by a body control module 270 and transmitted to the MCU 230, the power supply module 220, and the like, after passing through a filter 260.

The light source 210 may include a plurality of LED arrays such as the first, second, third, and fourth LED arrays 212, 214, 216, and 218. Although in an exemplary embodiment of the present inventive concept the light source 210 is illustrated as including the first to fourth LED arrays 212 to 218, the present inventive concept is not limited thereto. For example, the first to fourth LED arrays 212 to 218 may be provided as light sources for different uses with respect to each other, and may output light having different colors, different levels of brightness, and the like, with respect to each other. For example, when the first LED array 212 is used to provide a low beam of an automotive headlamp and the second LED array 214 is used to provide a high beam of an automotive headlamp, the second LED array 214 may output light with higher intensity than that of the first LED array 212 at a high optical axis.

The LED lighting device 200 illustrated in FIG. 5 may have a smaller number of power supply modules 220 than the number of the plurality of LED arrays 212 to 218 included in the light source 210. Referring to FIG. 5, a single power supply module 220 supplies driving power to the plurality of LED arrays 212 to 218, and the operation of the power supply module 220 may be controlled by the MCU 230.

The MCU 230 may include an information acquisition module 240, a control module 250, and the like. The information acquisition module 240 and the control module 250 may be provided as a single MCU 230, and according to an exemplary embodiment of the present inventive concept, the power supply module 220 may also be provided in a single MCU 230 together with the information acquisition module 240 and the control module 250.

The information acquisition module 240 may acquire bin data and temperature of LED elements included in the plurality of LED arrays 212 to 218, the input/output voltage, the input/output current, and the like, of the power supply module 220. The control module 250 may adjust the operation of the plurality of LED arrays 212 to 218 by controlling the operation of the power supply module 220, based on the data acquired by the information acquisition module 240.

The control module 250 may include a DC/DC controller 252 and a linear controller 254. In an exemplary embodiment of the present invention, the DC/DC controller 252 may be a circuit controlling the operation of the DC/DC converter included in the power supply module 220, capable of changing a level of power output from the power supply module 220 by controlling a duty ratio of a switching element included in the DC/DC converter. The linear controller 254 may be a circuit linearly controlling the output of the power supply module 220. In an exemplary embodiment of the present inventive concept, the linear controller 254 may control an operation of a current regulator disposed between the respective LED arrays 212 to 218 and a ground terminal. For example, in the circuit diagram illustrated in FIG. 5, the power supply module 220 may include a current regulator together with a DC/DC converter.

The MCU 230 may be connected to the body control module 270 to allow communications through a communications protocol such as CAN, LIN, FLEXRAY, and the like. The MCU 230 may perform an active control such as changing the optical axis of the LED arrays 212 to 218 or increasing or decreasing the amount of light that is output from the LED arrays 212 to 218, respectively, based on the automobile operating data received from the body control module 270.

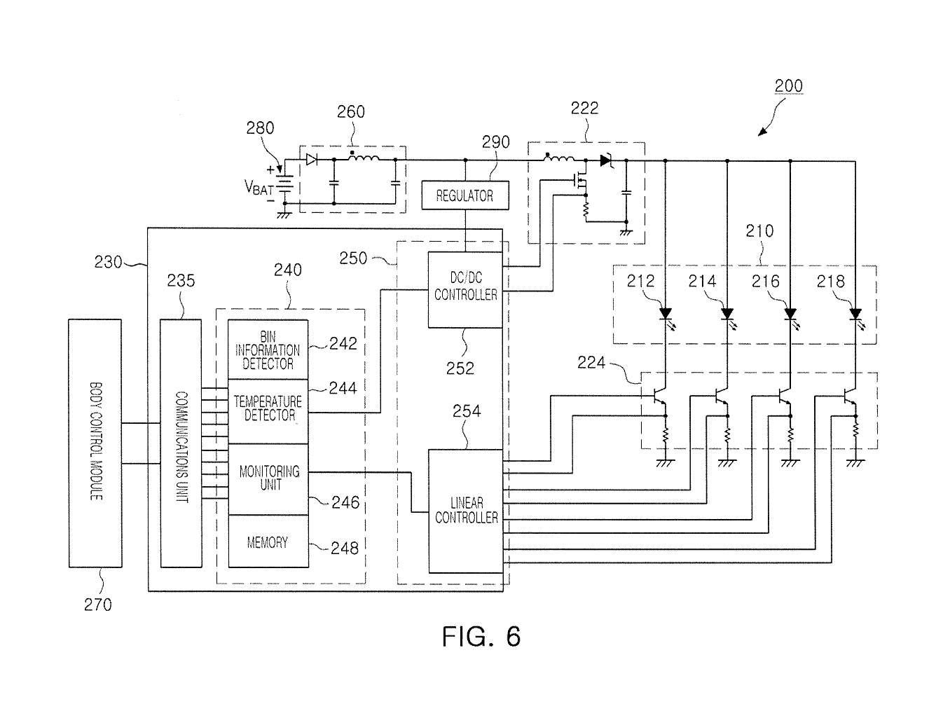

FIG. 6 illustrates a circuit diagram of the LED lighting device of FIG. 5, according to an exemplary embodiment of the present inventive concept.

Referring to FIG. 6, the input power required for the operation of the LED lighting device 200 may be output by the battery 280 of an automobile and transmitted to the filter 260. The input power from which noise components have been removed by the filter 260 may be converted to the appropriate power for operating the MCU 230 in the regulator 290 and may be input to the MCU 230. The input power passed through the filter 260 may be transmitted to a DC/DC converter 222.

Although the DC/DC converter 222 in FIG. 6 is illustrated as a buck converter, the DC/DC converter 222 may also include a different type of boost converter, a buck-boost converter, and the like. The operation of the DC/DC converter 222 may be controlled by a DC/DC controller 252 included in the MCU 230. The DC/DC controller 252 may supply a PWM signal to a control terminal of a switching element included in the DC/DC converter 222, and the output of the DC/DC converter 222 may increase or decrease according to a duty ratio of the PWM signal. The driving power output by the DC/DC converter 222 may be supplied to the plurality of LED arrays 212 to 218 connected to each other in parallel.

The DC/DC controller 252 may adjust a switching frequency of the DC/DC converter 222 using a software program. In a case in which the LED lighting device 200, according to an exemplary embodiment of the present inventive concept, is applied to an automotive headlamp, an electromagnetic wave condition required for each car model may be different. In an exemplary embodiment of the present inventive concept, the DC/DC controller 252 may control the switching frequency of the DC/DC converter 222 according to a spread spectrum scheme by using a software program. Here, the scope of the spread spectrum may not be assigned as a fixed value, and may be changed depending on the software settings.

A current regulator 224 may be disposed between the plurality of LED arrays 212 to 218 connected to each other in parallel and the ground terminal. The current regulator 224 may include a switching element and a resistor as circuits supplying constant current to the plurality of LED arrays 212 to 218. The operation of the plurality of LED arrays 212 to 218 may be controlled by a linear controller 254 included in the MCU 230.

The MCU 230 may include a communications unit 235 connected to a body control module 270 to allow communications, an information acquisition module 240, and a control module 250. As described above, the control module 250 may include the DC/DC controller 252, and the linear controller 254 controlling the operations of the DC/DC converter 222 and the current regulator 224.

The information acquisition module 240 may include a bin information detector 242 collecting bin data related to the LED elements included in the LED arrays 212 to 218, a temperature detector 244 measuring temperatures of the LED elements, a monitoring unit 246 detecting input/output voltage, input/output current information, and the like, of the current regulator 224 and the DC/DC converter 222, a memory 248, and the like. The memory 248 may store a lookup table recording the current-voltage characteristic data, the current-output characteristic data, or the junction temperature-output characteristic data related to the LED elements.

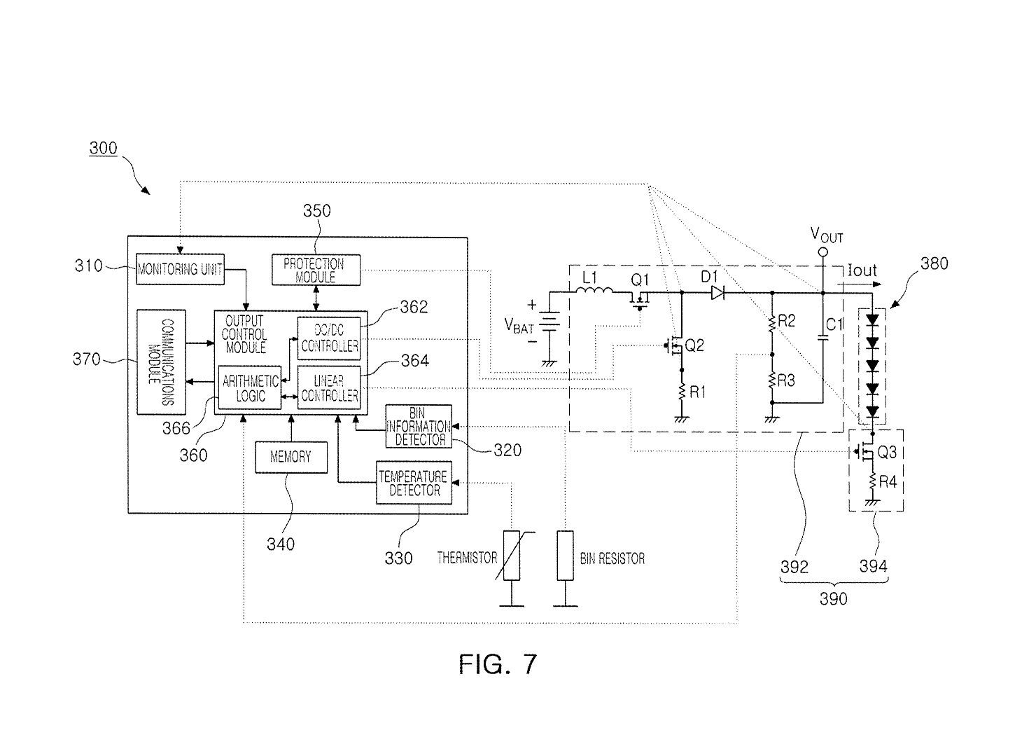

FIG. 7 is a diagram illustrating an MCU that may be applied to an LED driving device, according to an exemplary embodiment of the present inventive concept.

Referring to FIG. 7, an MCU 300 may include a monitoring unit 310, a bin information detector 320, a temperature detector 330, a memory 340, a protection module 350, an output control module 360, a communications module 370, and the like. The output control module 360 may include a DC/DC controller 362 and a linear controller 364, and the level of an output voltage V_{OUT} and a current I_{OUT} supplied to an LED array 380 may be adjusted by the output control module 360.

A power supply module 390 supplying the output voltage V_{OUT} and the output current I_{OUT} to the LED array 380 may include a DC/DC converter 392, a current regulator 394, and the like. FIG. 7 illustrates a DC/DC converter 392 implemented as a boost converter topology by an inductor L1, a switching element Q2, a diode D1, and a capacitor C1. The DC/DC converter 392 may also be implemented as a range of topologies such as a buck converter, a buck-boost converter, a Single-Ended Primary-Inductor Converter (SEPIC) converter, and the like, instead of the a boost converter. Resistors R1, R2 and R3 included within the DC/DC converter 392 may be provided as resistors for monitoring the operating status of the DC/DC converter 392 by the monitoring unit 310. The current regulator 394 having a switch element Q3 and a resistor R4 may be disposed between the LED array 380 and the ground terminal.

The bin information detector 320 may detect bin data related to LED elements included in the LED array 380 by being connected electrically to a bin resistor, and the temperature detector 330 may detect the temperature of the LED array 380 by being connected to a thermistor. Bin data and the temperature of the LED elements may be transmitted to the output control module 360 to control the output voltage V_{OUT} and the output current I_{OUT} transmitted to the LED array 380, or may be used for preventing damage to the LED elements, and to protect the LED elements.

The memory 340 may store current-voltage characteristic data, junction temperature-current characteristic data, current-output characteristic data, and the like, of the LED elements. The memory 340 may store the characteristic data related to the LED elements in the form of a lookup table. The output control module 360 may control the output voltage V_{OUT} and the current I_{OUT} with reference to the characteristic data stored in the memory 340.

The protection module 350 may be a module provided to prevent damage to the LED array 380, the DC/DC converter, and the like, and may be connected to a control terminal of a switching element Q1 included in the power supply module 390. For example, in a case in which the temperature detected by the temperature detector 330 is close to or exceeds a temperature limit of the LED elements, the protection module 350 turns the switching element Q1 off to block an input voltage V_{BAT} from being delivered to the DC/DC converter 392 to protect the LED array 380. The LED array 380 and the DC/DC converter 392 may be protected by operating the protection module 350 under a range of conditions in addition to temperature.

The output control module 360 may include a DC/DC controller 362 and a linear controller 364. The DC/DC controller 362 may control the duty ratio and the switching frequency of the switching element Q2 that determines the output of the DC/DC converter 392, and the linear controller 364 may control the operation of a switching element Q3 included in the current regulator 394. The output control module 360 may include an arithmetic logic 366 controlling operations of the switching elements Q2 and Q3 based on characteristic data read from the memory 340, operating data related to the power supply module 390, and the like, detected by the monitoring unit 310. The arithmetic logic 366 may control operations of the switching elements Q2 and Q3 by controlling outputs of the DC/DC controller 362 and the linear controller 364.

The operations of the switching elements Q2 and Q3 may be controlled by the arithmetic logic 366 included in the output control module 360, and the operations of the switching elements Q2 and Q3 may be controlled by a software program programmed in the arithmetic logic 366. For example, since the output of the LED array 380 may change according to the software program running in the arithmetic logic 366, the operation of the LED array 380 may be changed by modifying only the software running in the arithmetic logic 366. Therefore, an LED lighting device meeting customers' requirements and various guidelines may be provided by a software program modification alone, without the LED lighting device having to be redesigned or going through a change in hardware.

The arithmetic logic 366 included in the output control module 360 may control the operation of the protection module 350. The arithmetic logic 366 of the output control module 360 may set a threshold value for a plurality of parameters based on characteristic data read from the memory unit 340, operating data related to the power supply module 390 detected by the monitoring unit 310, and temperature and bin data detected by the temperature detector 330 and the bin information detector 320. The protection module 350 may adjust the operation of the switching element Q1 by comparing an actual measured value for each parameter to the threshold value set by the arithmetic logic 366. Thus, the LED elements may be actively protected according to the operating conditions and the environmental conditions that the LED elements are exposed to.

The communications module 370 may be provided as a module for communicating with an external controller provided separately with the MCU 300. For example, in a case in which the LED array 380 is provided partly as a light source of an automotive headlamp, the communications module 370 may be provided as a module for mediating communications between the MCU 300 and the body control module of the vehicle. The communications module 370 may operate according to various communications protocols such as Inter-Integrated Circuit (I2C), Serial Peripheral Interface (SPI), CAN, LIN, FLEXRAY, Media Oriented Systems Transport (MOST), and the like.

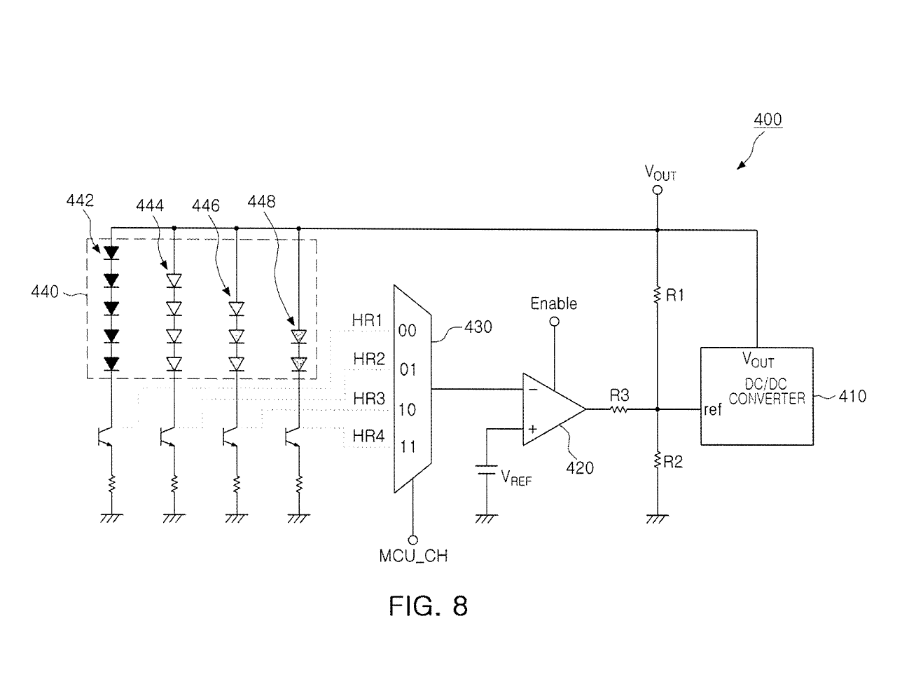

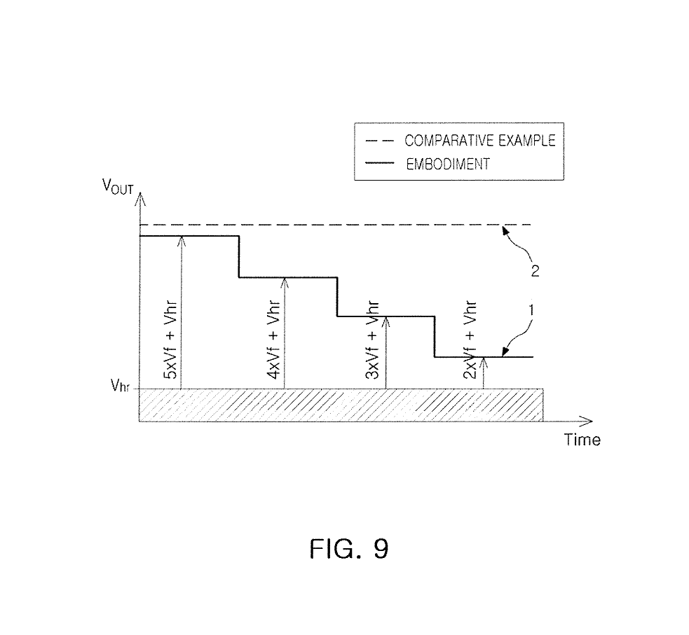

FIGS. 8 and 9 illustrate an active protection function of an LED driving device, according to an exemplary embodiment of the present inventive concept.

Referring to FIG. 8, an LED driving device 400, according to an exemplary embodiment of the present inventive concept, may include a DC/DC converter 410 applying a driving voltage to a light source 440 including a plurality of LED arrays, for example, a first LED array 442, a second LED array 444, a third LED array 446, and a fourth LED array 448, an operational amplifier 420 providing a reference signal ref to the DC/DC converter 410, and a multiplexer (MUX) circuit 430 selecting a signal applied to the input terminal of the operational amplifier 420. The DC/DC converter 410, as described previously, may be implemented in various topologies, such as a buck converter, a boost converter, a buck-boost converter, a SEPIC converter, a ZETA converter, and the like. The operation of the MUX circuit 430 may be controlled by a control signal MCU_CH provided by the above-described MCU 300.

The light source 440 may include the first and fourth LED arrays 442 to 448 connected to each other in parallel, and a current regulator may be connected between the first to fourth LED arrays 442 to 448 and the ground terminal. The number of LED arrays included in the light source 440 may be modified to be different from the number of LED arrays (e.g., the first to fourth LED arrays 442 to 448) shown in FIG. 8. In an exemplary embodiment of the present inventive concept, in a case in which the light source 440 is provided as an automotive headlamp, the first to fourth LED arrays 442 to 448 may be light sources provided with different roles with respect to each other, such as low beam lights, high beam lights, turn signal lights, daytime running lights, a positioning lamp, a fog lamp, and the like. In a case in which the light source 440 is provided as household lighting, the first to fourth LED arrays 442 to 448 may be light sources disposed in different locations with respect to each other, such as living room lighting, bathroom lighting, kitchen lighting, master bedroom lighting, porch lighting, and the like.

The first to fourth LED arrays 442 to 448 may be light sources provided for different functions and purposes with respect to each other, and may emit light of different colors or different levels of brightness with respect to each other. Therefore, as in an exemplary embodiment of the present inventive concept, with reference to FIG. 8, the first to fourth LED arrays 442 to 448 may include different numbers of LED elements with respect to each other. FIG. 8 illustrates the first LED array 442 including the most number of LED elements when compared to the second, third, and fourth LED arrays 444, 446, and 448, and the fourth LED array 448 including the least number of LED elements when compared to the first, second and third LED arrays 442, 444, and 446, but the number of LED elements included in the LED arrays is not limited thereto.

Since the first to fourth LED arrays 442 to 448 have different numbers of LED elements with respect to each other, an output voltage Vₒᵤₜ of the DC/DC converter 410 may be output at a level appropriate for an LED array that is actually turned on in the LED arrays 442 to 448, to increase power efficiency and to reduce stress applied to the LED elements. For example, when the first LED array 442 is turned on, the DC/DC converter 410 may output a sufficient level of the output voltage Vₒᵤₜ₁ to drive the first LED array 442. When the first LED array 442 is not turned on and the second LED array 444 is turned on, the DC/DC converter 410 may output an output voltage Vₒᵤₜ₂ having a level lower than that of the output voltage Vₒᵤₜ₁.

For the DC/DC converter 410 to actively adjust the level of the output voltage Vₒᵤₜ according to the characteristics of the turned-on first to fourth LED arrays 442 to 448, the operational amplifier 420 and the MUX circuit 430 may provide the reference signal ref determined according to the characteristics of the turned-on first to fourth LED arrays 442 to 448 to the DC/DC converter 410. For driving the respective first to fourth LED arrays 442 to 448, a forward voltage (Vf) determined by the number of LED elements included in each of the respective first to fourth LED arrays 442 to 448, and a headroom voltage (Vhr) required for the operation of constant current, may be required. Thus, when the forward voltages of the individual LED elements included in each of the respective first to fourth LED arrays 442 to 448 are all equal, the output voltages Vₒᵤₜ₁ to Vₒᵤₜ₄ required for driving the respective first to fourth LED arrays 442 to 448 may be determined using the following Formula 1:

Vₒᵤₜ₁=5·Vf+Vhr

Vₒᵤₜ₂=4·Vf+Vhr

Vₒᵤₜ₃=3·Vf+Vhr

Vₒᵤₜ₄=2·Vf+Vhr [Formula 1]

The output voltage V_{OUT1} required for driving the first LED array 442 may have the highest level, and the output voltage V_{OUT4} required for driving the fourth LED array 448 may have the lowest level.

When the first LED array 442 is turned on in the light source 440, a high signal may be transmitted to an input terminal HR1 of the MUX circuit 430. Similarly, when the second to fourth LED arrays 444 to 448 are respectively turned on, a high signal may be transmitted to input terminals HR2 to HR4 of the MUX circuit 430. The MUX circuit 430 may transmit the input signals transmitted to the respective input terminals HR1 TO HR4 to the operational amplifier 420, and the operational amplifier 420 may compare the transmitted inputs with a reference voltage V_{REF} and may transmit the comparison result to the DC/DC converter 410. The DC/DC converter 410 may receive the output of the current output voltage V_{OUT} and the output of the operational amplifier 420 through resistors R1 to R3, which may be used as the reference signal ref Hereinafter, the active protective function of the LED driving device 400 will be described in detail with reference to FIG. 9.

Referring to FIG. 9, levels of the output voltages V_{OUT} are shown with respect to time in a graph, according to an exemplary embodiment of the present inventive concept. The levels of the output voltages V_{OUT} of a comparative example are shown with respect to time in the graph of FIG. 9. Line 1 of the graph of FIG. 9 may correspond to the output voltage V_{OUT} in an example in which the first LED array 442, the second LED array 444, and the third LED array 446 are turned off sequentially as time passes, in a state where the first to fourth LED arrays 442 to 448 are all turned on, according to an exemplary embodiment of the present inventive concept. Alternatively, line 1 of the graph of FIG. 9 may correspond to an example in which the output voltage V_{OUT} of the first to fourth LED arrays 442 to 448 are sequentially turned on, respectively, as time passes, according to an exemplary embodiment of the present inventive concept.

Line 2 of FIG. 9 shows the levels of the output voltages V_{OUT} of a comparative example. In examining the comparative example, regardless of elapsed time, for example, regardless of the time in which the first to fourth LED arrays 442 to 448 are turned on, the output voltage V_{OUT} of the DC/DC converter 410 may be constantly maintained. Thus, the output voltage V_{OUT} of the DC/DC converter 410 needs to have a high level capable of driving the first LED array 442 that requires the highest driving voltage 5*Vf+Vhr, and consequently, in a case in which the first LED array 442 is turned on, power efficiency may be reduced.

In an exemplary embodiment of the present inventive concept, the output voltage V_{OUT} of the DC/DC converter 410 may be controlled actively in accordance with the turned-on first to fourth LED arrays 442 to 448. As illustrated in FIG. 9, the output voltage V_{OUT} corresponding to the level 5*Vf+Vhr required for driving the first LED array 442 may be generated during a time interval in which the first LED 442 is turned on. Since the first to fourth LED arrays 442 to 448 are connected to each other in parallel and receive the output voltage V_{OUT}, the second to fourth LED arrays 444 to 448 may also be turned on together while the output voltage V_{OUT} corresponding to 5*Vf+Vhr is applied to the first LED array. In this case, to reduce the stress applied to the LED elements included in the second to fourth LED arrays 444 to 448, and the second to fourth LED arrays 444 to 448 may be connected to at least one dummy diode.

In a case of turning on the second LED array 444 without turning on the first LED array, the output voltage V_{OUT} of a level corresponding to 4*Vf+Vhr may be output as illustrated in a second interval of FIG. 9. Thus, the first LED array 442 may not be turned on, and the second to the fourth LED arrays 444 to 448 may be turned on. As in the previous case, the third and fourth LED arrays 446 and 448 may be selectively connected to a dummy diode to protect the LED elements.

In an exemplary embodiment of the present inventive concept, the DC/DC converter 410 may actively control the level of the output voltage V_{OUT} so that the output voltage V_{OUT} corresponds to a voltage level adequate to turn on the LED array among the first to fourth LED arrays 442 to 448 requiring the highest driving voltage to be turned on. Therefore, power efficiency may be increased and stress applied to the LED elements may be reduced.

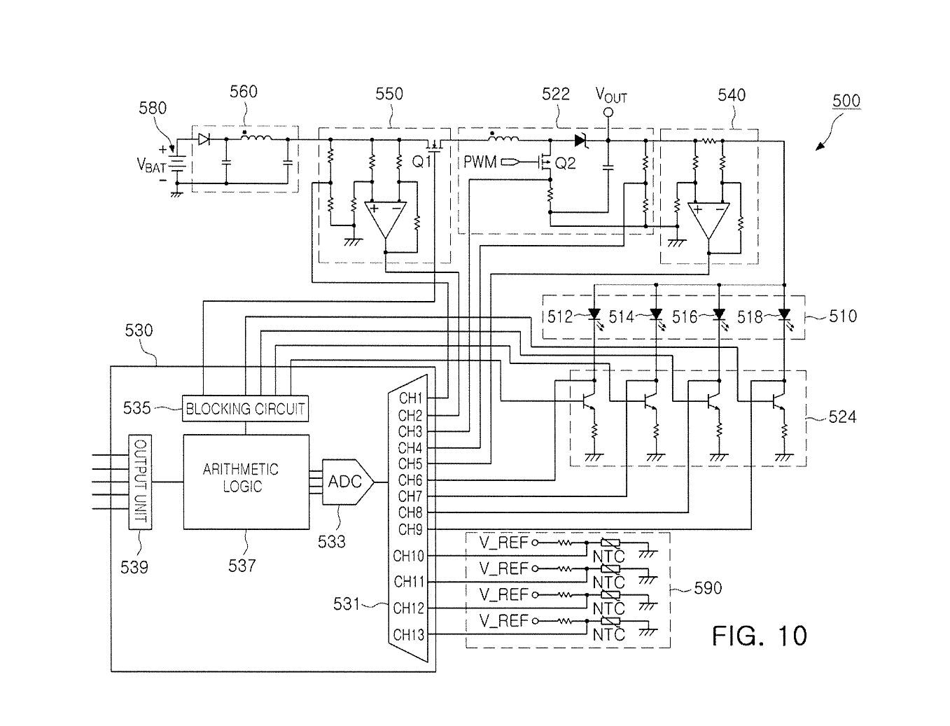

FIG. 10 illustrates an active protection function of an LED driving device, according to an exemplary embodiment of the present inventive concept.

Referring to FIG. 10, an LED driving device 500, according to an exemplary embodiment of the present inventive concept, may include power supply modules 522 and 524 supplying driving power to a light source 510 including a plurality of LED arrays, for example, first, second, third, and fourth LED arrays 512, 514, 516, and 518, a control module 530 controlling operations of the power supply modules 522 and 524, information acquisition modules 540 to 560 collecting and providing data required to control the operations of the power supply modules 522 and 524 by the control module 530, and the like. The power supply module 522 may be referred to as a DC/DC converter 522. The information acquisition module 560 may be referred to as a temperature detector 560.

Power required for the operation of the LED driving device 500 may be supplied from a power unit 580. When the light source 510 is provided for an automotive headlamp, an output voltage V_{BAT} of the power unit 580 may be a DC voltage in a range of approximately 9V-16V. In a case in which the light source 510 is provided for a household lighting system, the power unit 580 may output alternating current (AC) power. A filter unit may remove noise components, and the like, included in power output by the power unit 580.

The power removed of noise components by the filter unit may be input to an input power detector 550 and the DC/DC converter 522. The input power detector 550 may detect an input voltage and an input current transmitted to the DC/DC converter 522, and may transmit the input voltage and the input current to input channels 1 and 2, CH1 and CH2, of an MUX circuit 531 included in the control module 530, respectively. The DC/DC converter 522 may generate driving power required for the operation of the first to fourth LED arrays 512 to 518 included in the light source 510 by using the input power. The DC/DC converter 522 may be illustrated as a boost converter in FIG. 10, but may also be implemented in various topologies such as a buck converter, a buck-boost converter, a SEPIC converter, a ZETA converter, and the like.

The level of the driving power output by the DC/DC converter 522 may be determined by the duty ratio of a PWM signal applied to a control terminal of a switching element Q2 included in the DC/DC converter 522. A peak current may be detected in an output terminal of the switching element Q2 included in the DC/DC converter 522, and the detected peak current may be transmitted to an input channel 3 CH3 of the MUX circuit 531. The output voltage V_{OUT} generated by the DC/DC converter 522 may be detected by a voltage divider and transmitted to an input channel 4 CH4 of the MUX circuit 531.

The information acquisition module 540 may also be referred to as an output power detector 540. The output power detector 540 may be provided between an output terminal of the DC/DC converter 522 and the light source 510. The output power detector 540 may include a current detector circuit as in the input power detector 550. The output current of the DC/DC converter 522 may be detected via an output terminal of an operational amplifier included in the output power detector 540, and the detected output current may be transmitted to an input channel 5 CH5 of the MUX circuit 531.

The power supply module 524 may be referred to as a current regulator 524. The current regulator 524 may be connected between each of the first to fourth LED arrays 512 to 518 included in the light source 510 and a ground terminal. A voltage measured from a node between the current regulator 524 and the respective first to fourth LED arrays 512 to 518 may correspond to a headroom voltage required for driving constant current of the respective first to fourth LED arrays 512 to 518. The headroom voltage of the first to fourth LED arrays 512 to 518 may be respectively input to input channels 6, 7, 8, and to 9, CH6, CH7, CH8, and CH9 of the MUX circuit 531. The operation of the respective switching elements included in the current regulator 524 may be controlled by a blocking circuit 535. Temperature data related to the first to fourth LED arrays 512 to 518 determined from a thermistor included in the temperature detector 560 may be transmitted to input channels 10, 11, 12, and 13, CH10, CH11, CH12, and CH13 of the MUX circuit 531.

The input/output voltage, the input/output current, and the peak current of the DC/DC converter 522, the headroom voltage of the first to fourth LED arrays 512 to 518, the temperature data related to the first to fourth LED arrays 512 to 518, and the like, measured from the current regulator 524, may be transmitted to the plurality of input channels CH1 to CH13 of the MUX circuit 531. Additionally, bin data acquired from LED elements included in each of the first to fourth LED arrays 512 to 518 may be input to the MUX circuit 531.

The data input to the MUX circuit 531 may be converted into digital data by an ADC converter 533, and may be transmitted to an arithmetic logic 537. The arithmetic logic 537 may be capable of determining whether the first to fourth LED arrays 512 to 518 included in the light source 510 are operating normally based on the received data transmitted by the ADC converter 533. In a case in which the first to fourth LED arrays 512 to 518 are not determined to be operating normally, the arithmetic logic 537 may adjust operations of the DC/DC converter 522 and the current regulator 524 through the blocking circuit 535.

For example, when the input voltage detected by the input power detector 550 is determined to be high, the arithmetic logic 537 may block power supplied to the DC/DC converter 522 by turning off a switching element Q1 included in the input power detector 550 through the blocking circuit 535. In a case in which the voltage V_{OUT} output by the DC/DC converter 522 is determined to be low, the arithmetic logic 537 may increase a duty ratio of the PWM signal input to the switching element Q2. The MUX 531 includes an output unit 539 connected to the arithmetic logic 537. A voltage reference circuit 590 provides reference voltages to the arithmetic logic 537.

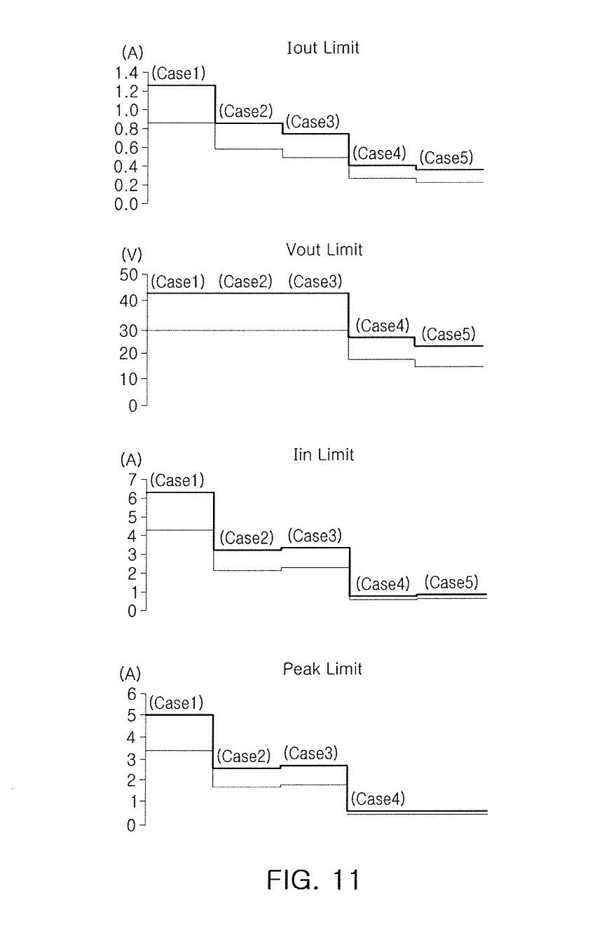

FIG. 11 illustrates a graph of the active control function of the LED driving device of FIG. 10, according to an exemplary embodiment of the present inventive concept. Referring to FIG. 11, a method for setting a threshold value of the output current, the output voltage, the input current, and the peak current for five cases is illustrated. In the four graphs illustrated in FIG. 11, the bold lines represents an upper threshold of the output current in Amperes, the output voltage in Volts, the input current in Amperes, and the peak current in Amperes, respectively, for five cases illustrated below in table 2. In FIG. 11, the thin lines represents a lower threshold of the output current in Amperes, the output voltage in Volts, the input current in Amperes, and the peak current in Amperes, respectively, for the five cases illustrated below in table 2. The five cases illustrated in FIG. 11 are also illustrated in Table 2 below. The light source 510 is assumed to be an automotive headlamp, and the first to fourth LED arrays 512 to 518 are assumed to be provided as low beam lights, high beam lights, daytime running lights, and turn signal lights, respectively.

TABLE 2

| Case | | Case 1 | Case 2 | Case 3 | Case 4 | Case 5 |
|---|---|---|---|---|---|---|
| Operating | Low Beam | ON | ON | OFF | OFF | OFF |
| Condition | High Beam | ON | ON | ON | OFF | OFF |
| | DRL | OFF | OFF | ON | OFF | ON |
| | Turn Signal | ON | OFF | OFF | ON | OFF |

| | | | | | |
|---|---|---|---|---|---|
| Output Current(A) | 1.05 | 0.72 | 0.62 | 0.34 | 0.29 |
| Output Voltage(V) | 35.8 | 35.8 | 35.8 | 21.8 | 18.9 |
| Input Current(A) | 5.25 | 2.68 | 2.78 | 0.61 | 0.63 |
| Peak Current(A) | 4.20 | 2.14 | 2.22 | 0.49 | 0.50 |
| Input Voltage(V) | 9 | 12 | 10 | 15 | 11 |
| Duty Ratio(%) | 75 | 67 | 72 | 31 | 42 |
| Operation Efficiency(%) | 80 | 80 | 80 | 80 | 80 |

In comparing Case 2 and Case 4 from Table 1, the output current, the output voltage, the input current, the peak current, the output voltage, and the duty ratio of Case 2 are all larger than those of Case 4. Since both the low beam and the high beam lights in Case 2 are in a turned-on condition, a large number of LED elements are turned on to output light having a high level of high luminance, and thus, a high level of output voltage and output current may be required. In case 4, since all of the low beam, the high beam, and the DRL are in a turned-off condition, and only the turn-signal is in a turned-on condition, the driving of the light source 510 may be enabled with a low level of output current and output voltage.

Referring to the graph of FIG. 11, Cases 1 to 5 are divided according to whether the low beam lights, the high beam lights, the daytime running lights, and the turn signal lights are respectively turned on or turned off, and threshold values of the output current, the output voltage, the input current, and the peak current may be set to be different from each other. Thus, in addition to protecting the LED elements included in the first to fourth LED arrays 512 to 518 by setting the voltage and the current of the DC/DC converter 522, the current regulator 524, and the like, differently with respect to each other for each separate operating condition, operating efficiency of the first to fourth LED arrays 512 to 518 may be increased. Referring to Table 1, the operating efficiency may be maintained in a constant state of 80% in a variety of operating conditions.

The functions of overcurrent protection, overvoltage protection, undervoltage lock out, overvoltage lock out, and the like, may be implemented by measuring actual values of various parameters such as input/output current, input/output voltage, peak current, and the like, and controlling the LED driving device 500 based on such values by the control module 530. The functions of overcurrent protection, overvoltage protection, undervoltage lock out, overvoltage lock out, and the like, may be implemented using software running in the control module 530.

In a case of implementing the over-current protection function using hardware in the control module 530, an over-current threshold value may be set when the voltage V_{BAT} of the input power 580 changes within a range of 9 V to 16V, based on a minimum voltage of 9V. Therefore, even in a case in which the voltage V_{BAT} of the input power 580 increases to 16V, the same over-current threshold value may be applied. However, according to an exemplary embodiment of the present inventive concept, a threshold current value to be applied to the overcurrent protection may be actively set according to the voltage V_{BAT} of input power 580. The threshold current value to be applied to the overcurrent protection may be determined by the software running on the control module 530.

In a case of implementing the over-voltage protection function with hardware, a threshold voltage value for the over-voltage protection may be set according to a minimum value and a maximum value of the forward voltage of each LED element. For example, in a case in which the forward voltage of each LED element is set to 2.75V at least and 3.75V at most, and an LED array includes 15 series-connected LED elements, the threshold voltage value for the overvoltage protection may be set to a maximum forward voltage of 56.25V. Thus, in a case in which a portion of the LED elements short circuits, whether or not the LED elements have been short circuited may not be determined since the total forward voltage of the LED array is still measured to be less than 56.25V, and the characteristics of the LED elements having different bin data with respect to each other may not be sufficiently reflected.

According to an exemplary embodiment of the present inventive concept, a voltage value reflecting a respective LED element of the light source 510 characteristic may be set as a threshold voltage value for overvoltage protection by measuring the bin data related to the LED elements of the light source 510. For example, when the minimum value and the maximum value of the forward voltage of each LED element of the light source 510 are 3.5V and 3.75V, respectively, in an LED array of the light source 510 having 15 LED elements connected to each other in series, the threshold voltage value for over-voltage protection may not be a specific value, but may be set within a range of 52.5V to 56.25V. Therefore, in a case in which a portion of the LED elements of the light source 510 are short circuited, whether or not the LED elements have been short circuited may be determined since the forward voltage of the entire LED array decreases to a level of 52.5V, the lower limit value of the range, or below.

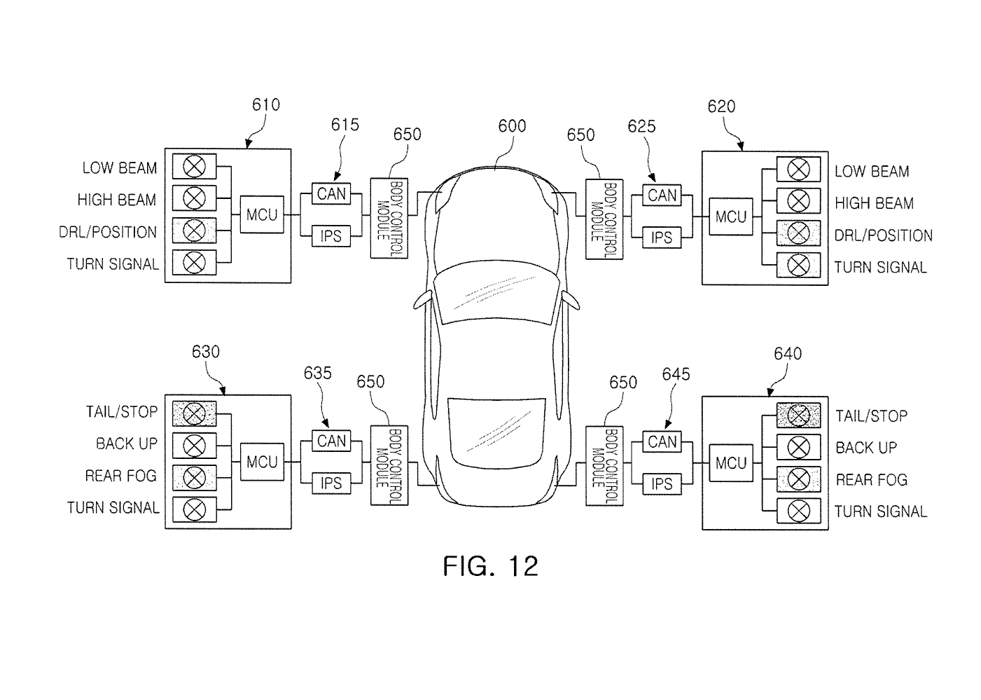

FIG. 12 illustrates the configuration of an automobile to which an LED driving device is applied, according to an exemplary embodiment of the present inventive concept.

Referring to FIG. 12, LED driving devices 610 and 620 may be applied to the headlamps of an automobile 600, and LED driving devices 630 and 640 may be applied to the tail lamps of the automobile 600, according to an exemplary embodiment of the present inventive concept. Each of the LED driving devices 610, 620, 630, and 640 may be connected to a vehicle body control module 650 to communicate therewith via communications protocols such as CAN. For example, the LED driving device 610 is connected to a vehicle body control module 650 using a communications protocol 615, for example, CAN. The LED driving device 620 is connected to a vehicle body control module 650 using a communications protocol 625, for example, CAN. The LED driving device 630 is connected to a vehicle body control module 650 using a communications protocol 635, for example, CAN. The LED driving device 640 is connected to a vehicle body control module 650 using a communications protocol 645, for example, CAN. An intelligent power switch (IPS) may be provided between each of the LED driving devices 610 to 640 and the body control module 650. The IPS may be used to detect a disconnection, a short circuit, overcurrent, and the like, of the LED driving devices 610 to 640.

FIG. 12 illustrates the LED driving devices 610 and 620 being provided on the left and right headlamps of the automobile 600, respectively, and the LED driving devices 630 and 640 being provided on the left and right tail lamps of the automobile 600, respectively. However, other configurations may be provided in addition to the configuration illustrated in FIG. 12. For example, one LED driving device may control the operation of the left and right headlamps of the automobile 600, and another LED driving device may control the operation of the left and right tail lamps of the automobile 600. In addition, a single LED driving device may control the left and right headlamps and the left and right tail lamps of the automobile 600.

An LED driving device and an LED lighting device, in accordance with various exemplary embodiments of the present inventive concept, may be applied in various applications. Hereinafter, the various applications in which the LED driving device and the LED lighting device may be applied, according to various exemplary embodiments of the present inventive concept, will be described.

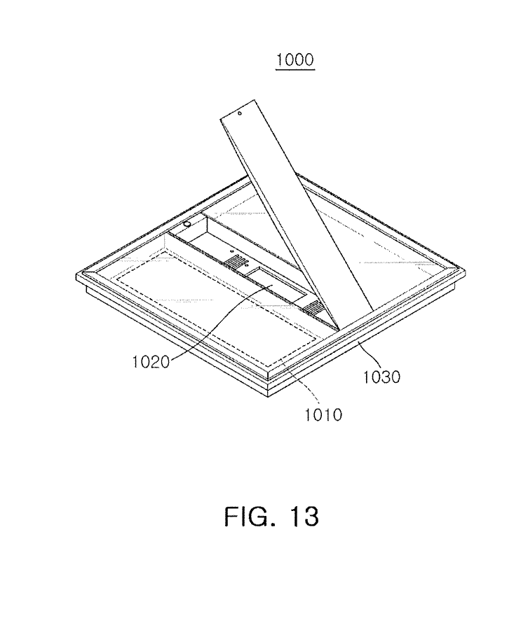

FIG. 13 is a perspective view illustrating a flat lighting device to which the LED driving device is applied, according to an exemplary embodiment of the present inventive concept.

Referring to FIG. 13, a flat lighting device 1000 may include a light source module 1010, a power supply device 1020, and a housing 1030. In accordance with an exemplary embodiment of the present inventive concept, the light source module 1010 may include a light-emitting element array as a light source, and the power supply device 1020 may include a light-emitting driving unit.

The light source module 1010 may include a light-emitting element array, and may be formed to have an overall planar shape. In accordance with an exemplary embodiment of the present inventive concept, the light-emitting element array may include light-emitting elements and a controller storing driving information of the light-emitting elements.

The power supply device 1020 may be configured to supply power to the light source module 1010. The housing 1030 may have a receiving space so that the light source module 1010 and the power supply device 1020 may be received therein, and may have a hexahedral shape of which one side is open, but is not limited thereto. The light source module 1010 may be disposed to emit light from an open side of the housing 1030.

An LED driving device, according to an exemplary embodiment of the present inventive concept, may be applied to the power supply device 1020. When a plurality of light source modules 1010 include LED arrays having different characteristics with respect to each other, the plurality of light source modules 1010 may be actively controlled and integrally protected, and power efficiency may be increased by applying the LED driving device to the power supply device 1020, according to an exemplary embodiment of the present inventive concept.

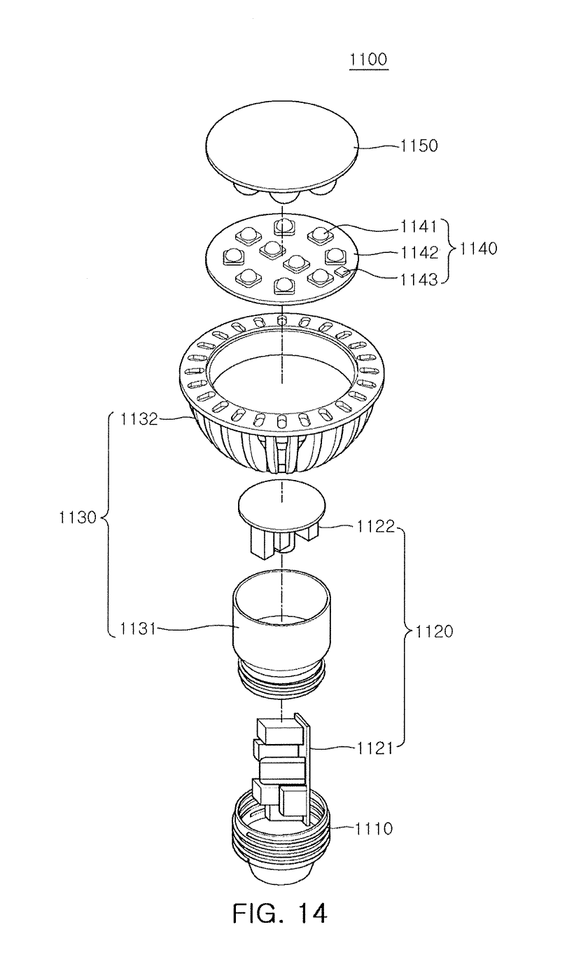

FIG. 14 is an exploded perspective view illustrating a bulb-type lamp as a lighting device to which an LED driving device is applied, according to an exemplary embodiment of the present inventive concept.

A lighting device 1100 may include a socket 1110, a power unit 1120, a heat radiating unit 1130, a light source module 1140, and an optical unit 1150. In accordance with an exemplary embodiment of the present inventive concept, the light source module 1140 may include a light-emitting element array, and the power unit 1120 may include a light-emitting element driving unit.

The socket 1110 may be configured to replace an existing lighting device. Power supplied to the lighting device 1100 may be applied through the socket 1110. As illustrated in FIG. 14, the power unit 1120 may include a first power unit 1121 and a second power unit 1122. The heat radiating unit 1130 may include an internal heat radiating unit 1131 and an external heat radiating unit 1132. The internal heat radiating unit 1131 may be connected directly to the light source module 1140 and/or the power unit 1120, through which heat may transfer to the external heat radiating unit 1132. The optical unit 1150 may include an internal optical unit and an external optical unit, and may be configured to distribute light emitted from the light source module 1140 evenly.

The light source module 1140 may emit light to the optical unit 1150 by receiving power from the power unit 1120. The light source module 1140 may include at least one light-emitting element 1141, a circuit board 1142, and a controller 1143, and the controller 1143 may be capable of storing driving information of the light-emitting elements 1141.

The LED driving device, according to an exemplary embodiment of the present inventive concept, may be provided as a controller 1143 and a power unit 1120. For example, a DC/DC converter, a current regulator, or the like, according to an exemplary embodiment of the present inventive concept, may be included within the power unit 1120 supplying driving power to the light-emitting elements 1141, and the controller 1143 may be provided as an MCU according to an exemplary embodiment of the present inventive concept. When at least a portion of a plurality of light-emitting elements 1141 included in the light source module 1140 are connected to each other in series to form two or more LED arrays, the lighting device 1100 may be efficiently controlled by applying thereto the LED driving device according to an exemplary embodiment of the present inventive concept thereto.

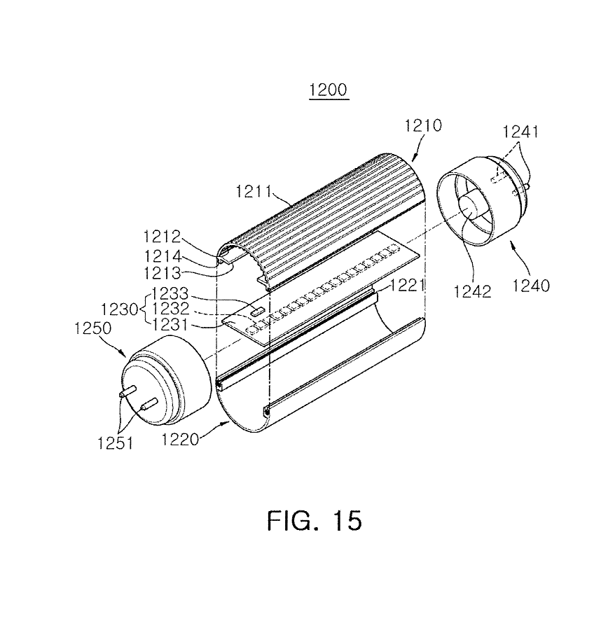

FIG. 15 is an exploded perspective view schematically illustrating a bar-type lamp as a lighting device to which an LED driving device is applied, according to an exemplary embodiment of the present inventive concept.

A lighting device 1200 may include a heat-radiating member 1210, a cover 1220, a light source module 1230, a first socket 1240, and a second socket 1250. A plurality of heat-radiating fins 1211 and 1212 may be formed on the internal and/or external surfaces of the heat-radiating member 1210 in a corrugated form, and the plurality of heat-radiating fins 1211 and 1212 may be designed to have various shapes and spacings. A protruded supporting fixture 1213 may be formed on the inside of the heat-radiating member 1210. The light source module 1230 may be fixed to the supporting fixture 1213. The locking projections 1214 may be formed on both sides of the heat-radiating member 1210 opposing each other.

A locking groove 1221 is formed in the cover 1220, and the locking projections 1214 of the heat-radiating member 1210 may be coupled to the locking groove 1221 in a hook coupling structure. The locations in which the locking groove 1221 and the locking projections 1214 are formed may be interchangeable with each other.

The light source module 1230 may include a light-emitting element array. The light source module 1230 may include a printed circuit board 1231, a light source 1232, and a controller 1233. As described above, the controller 1233 may store driving information of the light source 1232. Circuit wirings for operating the light source 1232 may be formed in the printed circuit board 1231. In addition, the light source module 1230 may include configuration elements for operating the light source 1232.

The first and second sockets 1240 and 1250, as a pair of sockets, have a structure in which they are coupled to both ends of a cylindrical cover unit of the heat-radiating member 1210 and the cover 1220. For example, the first socket 1240 may include an electrode terminal 1241 and a power device 1242, and a dummy terminal 1251 may be disposed on the second socket 1250. In addition, an optical sensor and/or a communications module may be provided in the first socket 1240 or the second socket 1250. For example, an optical sensor and/or a communications module may be provided in the second socket 1250 on which the dummy terminal 1251 is provided. As another example, an optical sensor and/or a communications module may be provided in the first socket 1240 on which the electrode terminal 1241 is disposed.

An LED driving device, according to an exemplary embodiment of the present inventive concept, may be provided as the power device 1242 and the controller 1233. Similar to an exemplary embodiment of the present inventive concept with reference to FIG. 14, a DC/DC converter and a current regulator may be included in the power device 1242, and the controller 1233 may include an MCU, according to an exemplary embodiment of the present inventive concept. When a plurality of light-emitting element arrays connected to each other in parallel are included in the light source module 1230, respective light-emitting element arrays may be actively controlled using the LED driving device, according to an exemplary embodiment of the present inventive concept.

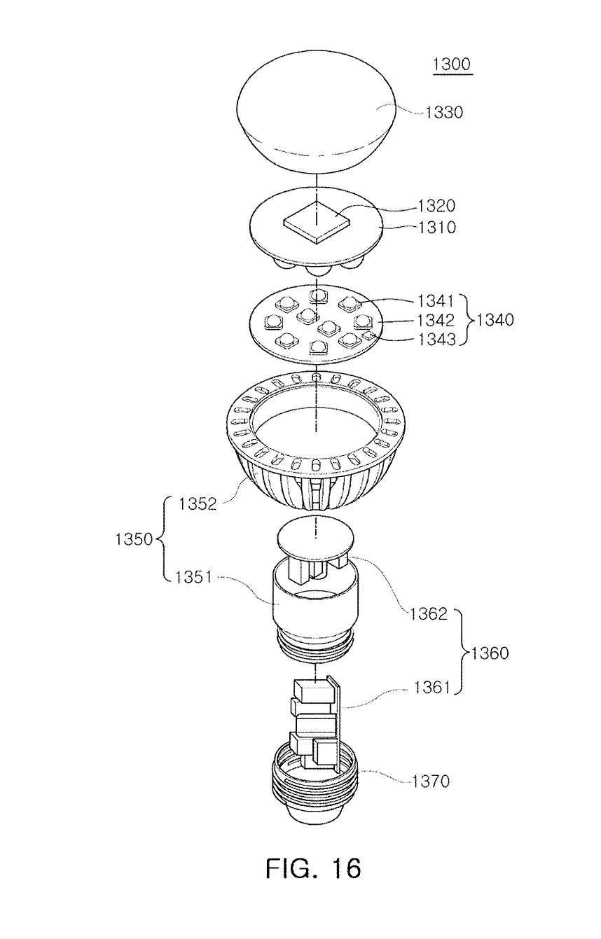

FIG. 16 is an exploded perspective view schematically illustrating a lamp including a communications module as a lighting device to which an LED driving device is applied, according to an exemplary embodiment of the present inventive concept.

A lighting device 1300, according to an exemplary embodiment of the present inventive concept, and the lighting device 1100 of FIG. 14 may have a difference in that a reflecting plate 1310 is provided on an upper portion of a light source module 1340, and the reflecting plate 1310 may reduce glare by allowing light emitted from a light source to be evenly diffused to the sides and the rear of the lighting device 1300.

A communications module 1320 may be mounted on an upper portion of the reflecting plate 1310, and home-network communications may be implemented via the communications module 1320. For example, the communications module 1320 may be a wireless communications module using ZIGBEE, WI-FI or LI-FI, and may control switching on/off operations, brightness, and the like, of lighting devices installed in and around the home via a smartphone or wireless controller. In addition, electronic products such as TVs, refrigerators, air conditioners, door locks, automobiles, vehicle systems, and the like, may be controlled with the use of a LI-FI communications module using visible light wavelengths from lighting devices installed in and around the home.

The reflecting plate 1310 and the communications module 1320 may be covered by a cover portion 1330. A socket 1370 may be configured to replace an existing lighting device. Power supplied to the lighting device 1300 may be applied through the socket 1370. As illustrated, a power unit 1360 may include a first power unit 1361 and a second power unit 1362 assembled together. A heat-radiating unit 1350 may include an internal heat-radiating unit 1351 and an external heat-radiating unit 1352. The internal heat-radiating unit 1351 may be connected directly to the light source module 1340 and/or the power unit 1360, through which heat may transfer to the external heat-radiating unit 1352. Similar to an exemplary embodiment of the present inventive concept with reference to FIG. 14, an LED driving device according to an exemplary embodiment of the present inventive concept may also be applied to the lighting device 1300 shown in FIG. 16.

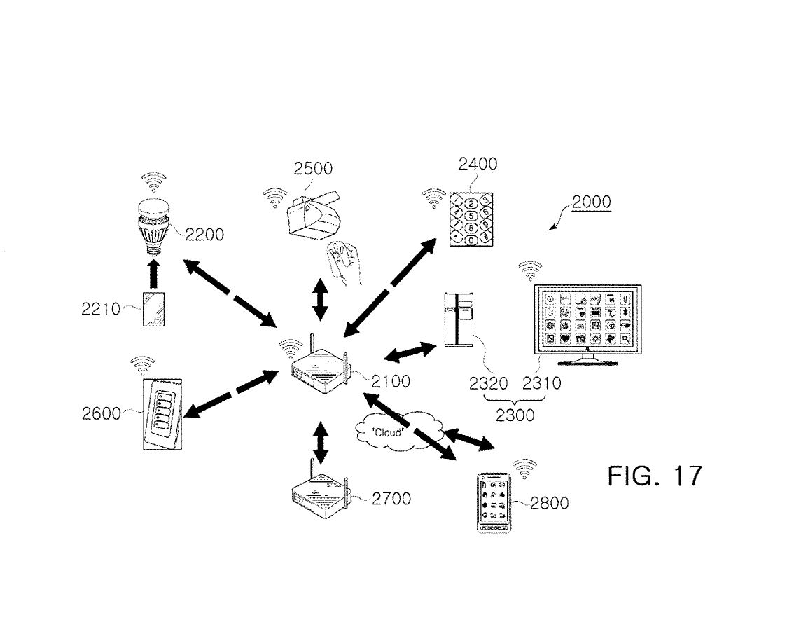

FIG. 17 is a schematic view illustrating an indoor lighting control network system, according to an exemplary embodiment of the present inventive concept.

A network system 2000, according to an exemplary embodiment of the present inventive concept, may be a smart lighting-network system fused with lighting technology using light-emitting elements such as LEDs, Internet of Things (IoT) technology, wireless communications technology, and the like. The network system 2000 may be implemented using a range of lighting devices and wired and wireless communications devices, and may be implemented by software for control and maintenance of sensors, controllers, communications means, network, and the like.

The network system 2000 may be applied not only to closed spaces within buildings such as homes or offices, but also to open spaces such as parks, streets, and the like. The network system 2000 may be implemented based on IoT environment to acquire and/or process and provide a range of information to users. In this case, an LED lamp 2200 included in the network system 2000 may not only control light of the LED lamp 2200 itself by receiving information of the surrounding environment from a gateway 2100, but also perform operations such as status verification, control, and the like, of other devices 2300 to 2800 included in the IoT environment based on visible light communications, and the like, of the LED lamp 2200.

Referring to FIG. 17, the network system 2000 may include the gateway 2100 for processing data transmitted and received in accordance with different communications protocols with respect to each other, the LED lamp 2200 connected to the gateway 2100 to allow communications and including LED light-emitting elements, and the plurality of devices 2300 to 2800 connected to the gateway 2100 to allow communications therewith according to various wireless communications methods. To implement the network system 2000 based on the IoT environment, the respective devices 2300 to 2800, including the LED lamp 2200, may include at least one communications module. In an exemplary embodiment of the present inventive concept, the LED lamp 2200 is connected to the gateway 2100 to allow communications by a wireless communications protocol such as WI-FI, ZIGBEE, LI-FI, and the like, and may have at least one communications module for a lamp 2210.

As described above, the network system 2000 may be applied not only to closed spaces such as homes or offices, but also to open spaces such as parks or streets. In a case in which the network system 2000 is applied to a home, the plurality of devices 2300 to 2800 included in the network system 2000, connected to the gateway 2100 to allow communications 2100 based on the IoT technology, may include home appliances 2300, digital door locks 2400, garage door locks 2500, light switches installed on walls 2600, routers 2700 for access to a wireless communications network, and mobile devices 2800 such as smart phones, tablets, laptop computers, and the like. The home appliances 2300 may include a television 2310 and a refrigerator 2320.

In the network system 2000, the LED lamp 2200 may verify operating statuses of the various devices 2300 to 2800 using a wireless communications network installed in the home (e.g., ZIGBEE, WI-FI, LI-FI, and the like), or automatically adjust the intensity of illumination of the LED lamp 2200 itself according to the surrounding environment and/or conditions. In addition, the devices 2300 to 2800 included in the network system 2000 may also be controlled using LI-FI communications using visible light emitted from the LED lamp 2200.

The LED lamp 2200 may automatically adjust the intensity of light of the LED lamp 2200 based on surrounding environment information transferred from the gateway 2100 through the communications module for a lamp 2220, or information of surrounding environment collected from a sensor mounted on the LED lamp 2200. For example, a brightness of the LED lamp 2200 may be automatically adjusted according to a brightness of a screen or the type of program being broadcast on the television 2310. The LED lamp 2200 may receive operation information of the television 2310 from the communications module for a lamp 2220 connected to the gateway 2100. The communications module for a lamp 2220 may be integrated as a module with the sensor and/or a controller included in the LED lamp 2200.

In a case in which the program being aired on TV is a documentary, the lighting may be lowered to a color temperature of 12000K or less, for example, 5000K, and the color may be adjusted, depending on a pre-set setting value, to create a cozy atmosphere. In a case in which the program is a comedy, the color temperature may be increased to 5000K or more according to a luminance setting value, and the network system may be configured to be adjusted to white light in a blue color series.

After a preset period of time passes in a case in which the digital door lock 2400 is locked in a state where no one is at home, all of the LED lamps 2200 that are turned on may be turned off to prevent electricity wastage. Alternatively, in a case in which a security mode is set via the mobile device 2800, or the like, and the digital door lock 2400 is locked in a state where no one is at home, the LED lamp 2200 may be kept turned on.

The operation of the LED lamp 2200 may be controlled according to the surrounding environment information collected from a range of sensors connected to the network system 2000. For example, when the network system 2000 is implemented in a building, lighting may be turned on or off by combining the lighting, the position of the sensor, and the communications module in a building, and by collecting location information of people in the building, or the collected information may be provided in real-time to enable facility management or efficient use of idle space. Since general lighting devices such as the LED lamps 2200 may be disposed in a majority of areas in each floor of a building, a range of information regarding the building may be collected via the sensors provided integrally with the LED lamps 2200, which may be used in facility management and use of idle space.

In addition, by combining the LED lamp 2200 with an image sensor, a storage device, the communications module for a lamp 2220, and the like, the LED lamp 2200 may be utilized as a device for maintaining security in a building or detecting and responding to emergencies. For example, in a case that a smoke detector or a temperature sensor, or the like, is provided in the LED lamp 2200, damage may be reduced by detection of fire, or the like. In addition, energy may be saved and a comfortable lighting atmosphere may be provided by controlling the brightness of the lighting in consideration of external weather conditions or sunlight.

An LED driving device, according to an exemplary embodiment of the present inventive concept, may be applied to the LED lamp 2200. When a plurality of LED lamps 2200 are provided in the network system 2000, the plurality of LED lamps 2200 may be integrally controlled by a single LED driving device. Further, the LED lamps 2200 may have different light-emitting characteristics and may be controlled actively and integrally, and power efficiency may be increased by setting and applying protection parameters adapted to the characteristics of each LED lamp 2200.

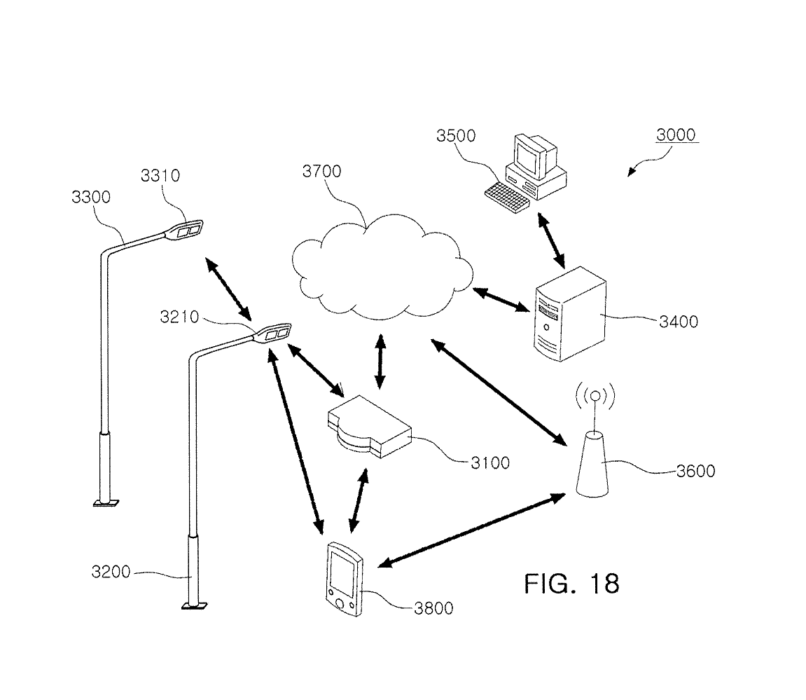

As described above, the network system 2000 may be applied not only to closed spaces such as homes, offices, or buildings but also to open spaces such as parks or streets. In a case of applying the network system 2000 to a large open space, it may be difficult to implement the network system 2000 due to factors such as a distance limit of wireless communications and communications interference due to various obstacles. The network system 2000 may be implemented in an open space as described above by mounting a sensor, a communications module, and the like, to respective lighting fixtures, and by using the respective lighting fixtures as information acquisition units and communications intermediate units, which will be described below with reference to FIG. 18.

FIG. 18 illustrates a network system 3000 applied to an open space, according to an exemplary embodiment of the present inventive concept. Referring to FIG. 18, the network system 3000, according to an exemplary embodiment of the present inventive concept, may include a communications connection device 3100, a plurality of lighting fixtures 3200 and 3300 connected to the communications connection device 3100 at predetermined distances to allow communications, a server 3400, a computer 3500 for managing the server 3400, a communications base station 3600, a communications network 3700 for connecting the above communications devices, and a mobile device 3800.

The plurality of lighting fixtures 3200 and 3300 installed in external open spaces, such as a street or a park, may respectively include smart engines 3210 and 3310. The smart engines 3210 and 3310 may include a sensor collecting information of a surrounding environment, a communications module, and the like, in addition to light-emitting elements, and a driver for driving the light-emitting elements. The smart engines 3210 and 3310 may communicate with other devices nearby by the communications module according to a communications protocol such as WI-FI, ZIGBEE, AND LI-FI.

For example, a single smart engine 3210 may be connected to another smart engine 3310 to enable communications therewith. In this case, a WI-FI extension technique (e.g., WI-FI mesh) may be applied to communications between the smart engines 3210 and 3310. At least one smart engine 3210 may be connected to the communications connection device 3100 connected to the communications network 3700 by a wired and/or wireless communications. To increase communications efficiency, a plurality of smart engines 3210 and 3310 may be coupled together as a single group and connected to a single communications connection device 3100.

The communications connection device 3100 may be an access point (AP) capable of allowing for wired and/or wireless communications, and may allow for intermediate the communications between the communications network 3700 and other devices. The communications connection device 3100 may be connected to the communications network 3700 in a wired or wireless manners, and for example, the communications connection device may be stored mechanically inside at least one of the lighting fixtures 3200 and 3300.

The communications connection device 3100 may be connected to the mobile device 3800 via a communications protocol such as WI-FI or the like. A user of the mobile device 3800 may receive information of a surrounding environment collected by the plurality of the smart engines 3210 and 3310 via the communications connection device 3100 connected to the smart engine 3210 of the lighting fixture 3200. The information of the surrounding environment may include surrounding traffic information, weather information, and the like. The mobile device 3800 may be connected to the communications network 3700 in a wireless cellular communication method such as a third generation of mobile telecommunications technology (3G) or a fourth generation of mobile telecommunications technology (4G) via the communications base station 3600.

The server 3400 connected to the communications network 3700 may receive information collected by the smart engines 3210 and 3310 mounted in the respective lighting fixtures 3200 and 3300, and simultaneously, may monitor an operation status, and the like, of the respective lighting fixtures 3200 and 3300. To manage the respective lighting fixtures 3200 and 3300 based on the monitoring result of the operation status of the respective lighting fixtures 3200 and 3300, the server 3400 may be connected to the computer 3500 providing a management system. The computer 3500 may run a software, and the like, capable of monitoring and managing the operation status of the respective lighting fixtures 3200 and 3300 using the smart engines 3210 and 3310.

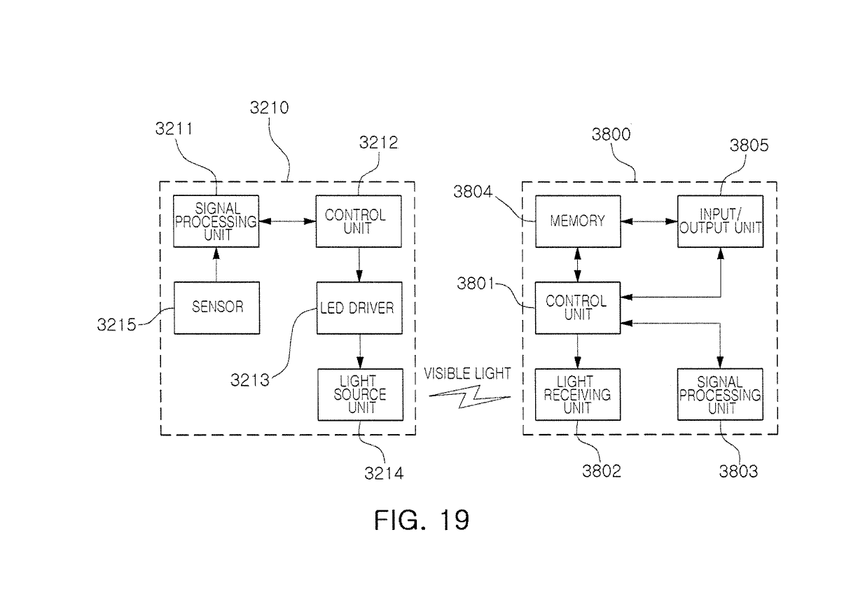

FIG. 19 is a block diagram illustrating an operation of the smart engine 3210 of the lighting fixture 3200 of FIG. 18 and the mobile device 3800 of FIG. 18 by visible light wireless communications. A range of communications methods may be applied to transfer the information collected by the smart engines 3210 and 3310 to a user's mobile device 3800. Referring to FIG. 19, the information collected by the smart engine 3210 may be transferred to the mobile device 3800 via the communications connection device 3100 which is connected to the smart engine 3210 and to the mobile device 3800. In addition, the smart engine 3210 may be connected directly to the mobile device 3800 to allow direct communications. In addition, the information collected by the smart engine 3310 may be transferred to the mobile device 3800 via the communications connection device 3100 which is connected to the smart engine 3310 and to the mobile device 3800. Further, the smart engine 3310 may be connected directly to the mobile device 3800 to allow direct communications. The smart engines 3210 and 3310 and the mobile device 3800 may communicate directly with each other by a visible light wireless communications, for example, LI-FI, which will be described below with reference to FIG. 19.

Referring to FIG. 19, the smart engine 3210 may include a signal processing unit 3211, a control unit 3212, an LED driver 3213, a light source unit 3214, a sensor 3215, and the like. The mobile device 3800 connected to the smart engine 3210 by visible light wireless communications may include a control unit 3801, a light receiving unit 3802, a signal processing unit 3803, a memory 3804, an input/output unit 3805, and the like.

The visible light wireless communications LI-FI technology may be a wireless communications technology for transmitting information wirelessly using light in a visible wavelength band recognized by the human eye. Such a visible light wireless communications technology may be distinguished from the existing wired optical communications technology and infrared wireless communications in that light in the visible light wavelength band is light that includes a specific visible light frequency emitted from the lighting fixtures or the lighting devices described above. Also, the visible light wireless communications technology may be distinguished from wired optical communications technology in that the communications environment of the visible light wireless communications technology is wireless. Further, the visible light wireless communications technology may be used freely, without being regulated by guidelines. Thus the visible light wireless communications technology may be convenient and the physical security thereof may be excellent. In the visible light wireless communications technology, the communications link may be checked by the user visually. The visible light wireless communications may emit visible light and may transmitting information wirelessly.

Referring to FIG. 19, the signal processing unit 3211 of the smart engine 3210 may process data to be transmitted and received by the visible light wireless communications. In an exemplary embodiment of the present inventive concept, the signal processing unit 3211 may acquire and process information collected by the sensor 3215 and may transmit the processed information to the control unit 3212. The control unit 3212 may control operations of the signal processing unit 3211, the LED driver 3213, and the like. The control unit 3212 may control the operation of the LED driver 3213 based on the processed information transmitted by the signal processing unit 3211. The LED driver 3213 may transmit data to the mobile device 3800 by allowing the light source unit 3214 to emit light in response to a control signal transmitted by the control unit 3212.

The mobile device 3800 may include the control unit 3801, the memory 3804 storing data, the input/output unit 3805 including a display, a touch screen, an audio output unit, and the like, the signal processing unit 3803, and the light receiving unit 3802 for recognizing visible light containing data. The light receiving unit 3802 may detect visible light and convert the visible light into an electrical signal, and the signal processing unit 3803 may decode the data contained in the electrical signal converted by the light receiving unit 3802. The control unit 3801 may store the data decoded by the signal processing unit 3803 in the memory 3804, or output the decoded data via the input/output unit 3805 to be recognized by the user.

In exemplary embodiments of the present inventive concept described with reference to FIGS. 18 and 19, the smart engine 3210 may include an LED driving device according to an exemplary embodiment of the present inventive concept. Referring to FIG. 19, the control unit 3212 may correspond to an MCU in an LED driving device according to an exemplary embodiment of the present inventive concept, and the LED driver 3213 may correspond to a power supply module. A single MCU may not only actively control and protect the light source unit 3214, but may also provide a visible light communications function.

As described above, according to various exemplary embodiments of the present inventive concept, the operation of the power supply module may be controlled based on operating data related to the power supply module supplying driving power to a plurality of LED elements, as well as characteristic data related to the plurality of LED elements. Since the control module controlling the operation of the power supply module may be provided as a programmable MCU, by changing the operation of the control module by running a software program suitable for loading conditions, operating conditions, and surrounding conditions, LEDs may be actively driven and protected, and circuit configuration may be simplified.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A light emitting diode (LED) driving device comprising:
a power supply module configured to supply driving power to a light source, wherein the light source includes a plurality of LED elements;
an information acquisition module configured to acquire operating data of the power supply module and characteristic data of the plurality of LED elements; and
a control module configured to control an operation of the power supply module based on the operating data and the characteristic data,
wherein the information acquisition module and the control module are included in a programmable microcontroller unit (MCU), and
the MCU executes stored codes to provide control signals to the control module to operate the power supply module.

2. The LED driving device of claim 1, wherein the information acquisition module comprises a monitoring unit configured to detect an input voltage, an input current, an output voltage, or an output current of the power supply module,
a bin information detector is configured to detect bin data related to the plurality of LED elements,
a temperature detector is configured to detect a temperature of the plurality of LED elements, and
a memory unit is configured to store the characteristic data of the plurality of LED elements.

3. The LED driving device of claim 2, wherein the characteristic data of the plurality of LED elements comprises at least one of current-voltage characteristic data, current-output characteristic data, and junction temperature-output characteristic data, and
wherein the memory unit comprises a lookup table including the current-voltage characteristic data, the current-output characteristic data, or the junction temperature-output characteristic data of the plurality of LED elements.

4. The LED driving device of claim 3, wherein the control module selects at least one of the characteristic data included in the lookup table based on the bin data detected by the bin information detector, and controls the operation of the power supply module by applying the data detected by the monitoring unit and the temperature detector to the selected characteristic data.

5. The LED driving device of claim 1, wherein the control module comprises a protection module configured to determine whether to block input power supplied to the power supply module based on the operating data, and
an output control module is configured to control a voltage and a current being output by the power supply module based on the operating data or the characteristic data.

6. The LED driving device of claim 5, wherein the output control module comprises a Direct Current to Direct Current (DC/DC) controller configured to control a duty ratio of switching elements included in the power supply module, and a linear controller configured to control an output of the power supply module linearly.

7. The LED driving device of claim 1, further comprising a communications module included in the MCU, wherein the communications module is connected to an external controller to communicate with the external controller.

8. The LED driving device of claim 7, wherein the external controller is a body control module (BCM) of a vehicle.

9. The LED driving device of claim 1, wherein the plurality of LED elements are arranged in a plurality of LED arrays that operate independently of each other,
wherein a first array of the plurality of LED arrays is operated by a first driving voltage that is different from a second driving voltage that operates a second array of the plurality of LED arrays, and wherein the first array of the plurality of LED arrays is operated by a first driving current that is different from a second driving current that operates the second array of the plurality of LED arrays.

10. The LED driving device of claim 9, wherein the control module controls the operation of the power supply module when at least one LED array of the plurality of LED arrays is selected to operate based on a driving voltage and a driving current required to operate the selected LED array.

11. The LED driving device of claim 1, wherein the MCU includes the power supply module, the information acquisition module, and the control module.

12. A light emitting diode (LED) lighting device comprising:
a light source including a plurality of LED arrays;
a power supply module configured to generate driving power to operate the plurality of LED arrays; and
a control module included in a microcontroller unit (MCU) and configured to operate the power supply module based on characteristic data of the plurality of LED arrays and operating data related to the power supply module,
wherein the control module includes a stored program executed by the MCU.

13. The LED lighting device of claim 12, wherein the light source is included in an automotive headlamp, and the plurality of LED arrays provides illumination for low beam lights, high beam lights, daytime running lights (DRL), or turn signal lights of the automotive headlamp.

14. The LED lighting device of claim 12, wherein the operating data related to the power supply module includes an input voltage, an input current, an output voltage, or an output current of the power supply module, and the characteristic data related to the plurality of LED elements includes bin data, temperature data, current-voltage characteristic data, current-output characteristic data, and junction temperature-output characteristic data related to the plurality of LED elements.

15. The LED lighting device of claim 12, wherein the characteristic data related to the plurality of LED elements includes current-voltage characteristic data, current-output characteristic data, and junction temperature-output characteristic data,
wherein the control module controls the operation of the power supply module using the current-voltage characteristic data, the current-output characteristic data, and the junction temperature-output characteristic data related to the plurality of LED elements,
wherein the current-voltage characteristic data, the current-output characteristic data, and the junction temperature-output characteristic data related to the plurality of LED elements are stored in a lookup table.

16. A Light Emitting Diode (LED) lighting device comprising:
a light source module including a plurality of LEDs; and
a power supply module driving the plurality of LEDs,
wherein the light source module includes a controller configured to control an operation of the power supply module using a stored program executed by a microcontroller unit (MCU),
wherein the controller controls the operation of the power supply module using characteristic data of the plurality of LEDs and operating data of the power supply module, and
wherein the plurality of LEDs is arranged into a plurality of LED strings, each LED string of the plurality of LED strings being independently driven by the power supply module.

17. The LED lighting device of claim 16, wherein the operating data of the power supply module includes an input voltage, an input current, an output voltage, or an output current of the power supply module, and the characteristic data of the plurality of LEDs includes bin data, temperature data, current-voltage characteristic data, current-output characteristic data, and junction temperature-output characteristic data related to the plurality of LEDs.

18. The LED lighting device of claim 16, wherein the characteristic data of the plurality of LEDs includes current-voltage characteristic data, current-output characteristic data, and junction temperature-output characteristic data,
wherein the controller controls the operation of the power supply module using at least one of the current-voltage characteristic data, the current-output characteristic data, and the junction temperature-output characteristic data related to the plurality of LED elements, and
wherein the current-voltage characteristic data, the current-output characteristic data, and the junction temperature-output characteristic data of the plurality of LEDs are stored in a lookup table.

19. The LED lighting device of claim 16, further comprising a communications module included in the MCU, wherein the communications module is connected to an external controller and is configured to communicate with the external controller.

20. The LED lighting device of claim 19, wherein the communications module communicates with the external controller using one of visible light wireless communications (LI-FI), WI-FI, and ZIGBEE.
